(19) United States
(12) Patent Application Publication
(10) Pub. No.: US 2025/0098682 A1
(43) Pub. Date: Mar. 27, 2025

(54) ANTIMICROBIAL COATING COMPOSITIONS

(71) Applicant: Polaroid IP B.V., Enschede (NL)

(72) Inventor: Rong-Chang Liang, Cupertino, CA (US)

(73) Assignee: Polaroid IP B.V., Enschede (NL)

(21) Appl. No.: 18/373,686

(22) Filed: Sep. 27, 2023

Related U.S. Application Data
(60) Provisional application No. 63/410,714, filed on Sep. 28, 2022.

(51) Int. Cl. A01N 47/40; A01N 25/04; A01P 1/00

(52) U.S. Cl. CPC A01N 47/40; A01N 25/04; A01P 1/00

(57) ABSTRACT

Described herein are quaternary ammonium polymers and compositions with broad spectrum antimicrobial properties that produce fast acting, long lasting, non-toxic and non-allergenic colorless and transparent durable surface coatings that are resistant to water and common solvents. The surface coatings are easy and cost effective to produce from readily-available materials using versatile synthesis enabling a wide range of chemical variations. Such coatings are readily applied to a wide range of surfaces and materials, and no materials leach out of the coatings.

### CROSS-REFERENCE TO RELATED APPLICATIONS

This application claims the benefit of priority to U.S. Provisional Patent Application No. 63/410,714, filed Sep. 28, 2022, which is hereby incorporated by reference herein in its entirety.

### FIELD

The embodiments of the present disclosure relate to broad spectrum antimicrobial coating compositions and methods of using the same. More specifically, embodiments of the present disclosure relate to quaternary ammonium polymer structures and formulations with broad spectrum antibacterial and antiviral properties.

### BACKGROUND

Infectious diseases including influenza kill millions of people globally per year and sicken hundreds of millions. Since 2020, the world has experienced a global COVID-19 pandemic caused by a highly transmissible novel coronavirus, severe acute respiratory syndrome coronavirus 2 (SARS-CoV-2).

The SARS-CoV-2 coronavirus and/or other viruses before it, have been shown to be transmitted from person to person as airborne droplets but may also be transmissible by touching surfaces contaminated with the virus. A 2020 study done at two major urban U.S. hospitals¹ concluded that there was a 36% decline in healthcare-associated infections when commonly touched surfaces (keyboards, countertops, railings, chairs, etc.) were coated with a disinfectant. Indeed, disinfecting surfaces was adopted as a widespread health safety practice during the COVID-19 pandemic but with limited effectiveness because antiviral coatings become ineffective after a short time requiring costly and labor-intensive frequent re-application.

Over the years, there have been numerous antimicrobial polymers developed in an attempt to provide more effective antibacterial/antiviral surface coatings. A recent review by Jarach et al. (2020)² highlights some of the different polymer approaches to this problem. These polymers include nanoparticles with attached or adsorbed drugs, nanoparticles with embedded antiviral metals, naturally occurring polymers such as chitosan, silica particles with adsorbed quaternary ammonium salts and quaternary polyethyleneimines (PEI's).

Desirable antimicrobial surface coatings would have the following properties: (i) broad spectrum antimicrobial activity at a low Minimum Inhibition Concentration (MIC); (ii) fast acting; (iii) long lasting; (iv) non-toxic and nonallergenic; (v) no materials leaching out of the coating; (vi) acceptable color, transparency and appearance as a surface coating; (vii) easy application to a wide range of surfaces and materials; (viii) durability and resistance to water, alcohol and common solvents; and (ix) easy and cost effective to produce.

As appreciated by the inventors of the present application, conventional antimicrobial surface coatings lack many of the above-listed characteristics. Accordingly, there is a need for improved antimicrobial surface coating compositions.

### SUMMARY

The embodiments of the present technology provide water-based quaternary ammonium polymeric coating formulations that can be applied to a wide range of surfaces to render them broadly antimicrobial. Unlike conventional coatings, the water-based coatings disclosed herein (i) exhibit broad spectrum antimicrobial activity at a low Minimum Inhibition Concentration (MIC); (ii) are fast acting; (iii) long lasting; (iv) non-toxic and nonallergenic; (v) have no materials leaching out of the coating; (vi) have acceptable color, transparency and appearance as a surface coating; (vii) are easy to apply to a wide range of surfaces and materials; (viii) produce durable surface coatings that are resistant to water, alcohol and common solvents; and (ix) are easy and cost-effective to produce.

In one aspect, described herein is a use of a reactive low molecular-weight quaternary ammonium salt comprising a long-chain hydrophobic group that renders the salt with high surface activity and emulsification efficacy in water. Upon reacting the reactive quaternary ammonium salt with a multifunctional crosslinker (such as a polyisocyanate) and optionally an oligomeric polyol and/or chain extender, the resultant reaction mixture becomes readily emulsifiable in water with excellent emulsion stability, particularly in the presence of a water-soluble polymer as a protective colloid. The resultant emulsion can be coated or sprayed onto a variety of surfaces or substrates while the chain extension or crosslinking reactions are continuing in the oil phase to form a highly durable antimicrobial coating after the film is dried and optionally post-cured. In some embodiments, the reactive low molecular-weight quaternary ammonium salt comprises a long-chain hydrophobic group on a nitrogen of the quaternary ammonium salt.

In another aspect, described herein is a use of a reactive water-soluble protective colloid that forms an interpenetration network with the antimicrobial polymers in the oil phase to further improve the durability of the resultant coating.

In another aspect, described herein is a use of a surface-active polyol in the oil phase to further improve the emulsion stability, reduce the particle size of the resultant emulsion, and improve the coating quality.

In another aspect, described herein is a use of a blocking agent to protect the reaction product of the reactive surface-active quaternary ammonium salt with the multifunctional crosslinker before the emulsification step to further improve the emulsion stability and processability or green-time of the emulsion. The blocking agent is de-blocked optionally in the presence of a catalyst or sensitizer, by for example, heat or radiation during or after the drying and/or post curing steps to obtain a durable coating.

The antimicrobial efficiency of organic solvent-based antimicrobial coatings generally decreases with an increasing crosslinking density of the coating. A high degree of crosslinking is often required for acceptable coating properties including durability and resistance against organic solvents, alcohol, water, detergent and various disinfection solutions and processes. Unfortunately, the bioactive functional group in the organic solvent-based coatings tends to be trapped in the crosslinking network when the degree of crosslinking is high. Unlike such organic solvent-based antimicrobial coatings, the high surface activity of the reactive quaternary ammonium salt of the present technology allows the bioactive functional group including quaternary ammonium group to diffuse to the interface of the emulsion droplet, and in turn the surface of the resultant coating. As a result, durable coatings with desirable physical and chemical properties as well as a high antimicrobial efficiency can be achieved at the same time through use of the present technology.

In an aspect, provided is an antimicrobial composition comprising an oil-in-water emulsion, the oil-in-water emulsion comprising (i) an oil phase comprising a first adduct of a first multifunctional crosslinker and a first quaternary ammonium salt, wherein the first quaternary ammonium salt has a reactive linking group to react with the first multifunctional crosslinker; a polyol; and optionally a second multifunctional crosslinker; and (ii) an aqueous phase comprising a water-soluble polymer.

In an aspect, provided is an antimicrobial composition, wherein the water-soluble polymer is crosslinked with one or both of the first adduct and the second multifunctional crosslinker.

In an aspect, the first quaternary ammonium salt has a chemical structure of

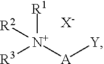

wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹—(CR^{p}R^{q})_{y11}H—; wherein —(C₈-C₆₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl), —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl); —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹, and W⁴¹ are independently selected from 5- to 6-membered cycloalkyl, C₆-C₁ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴,

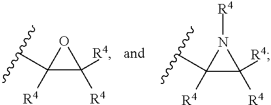

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁₀ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from O, S, and Si.

In an aspect, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si.

In an aspect, R² and R³ are methyl.

In an aspect, A is —(CH₂)ₘ— or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In an aspect, each R⁵ is independently H or methyl.

In an aspect, the first quaternary ammonium salt is

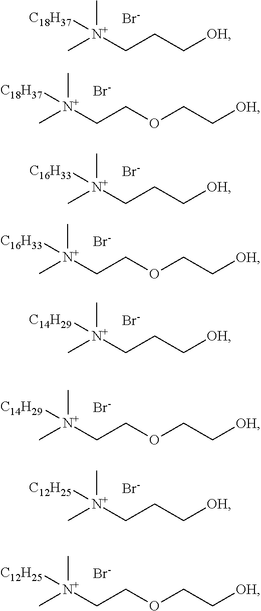

or a combination of two or more thereof.

In an aspect, the first quaternary ammonium salt is present in the oil phase in an amount of about 10% to about 50% by weight based on the dry weight of the oil phase.

In an aspect, the first quaternary ammonium salt is present in the oil phase in an amount of about 15% to about 35% by weight based on the dry weight of the oil phase.

In an aspect, the first quaternary ammonium salt is present in the oil phase in an amount of about 20% to about 30% by weight based on the dry weight of the oil phase.

In an aspect, the first multifunctional crosslinker, which is incorporated into the first adduct, is present in the oil phase in an amount of about 5% to about 25% by weight based on the dry weight of the oil phase.

In an aspect, the first multifunctional crosslinker, incorporated into the first adduct, is present in the oil phase in an amount of about 5% to about 20% by weight based on the dry weight of the oil phase.

In an aspect, the second multifunctional crosslinker is present in the oil phase in an amount of about 5% to about 25% by weight based on the dry weight of the oil phase.

In an aspect, the second multifunctional crosslinker is present in the oil phase in an amount of about 5% to about 20% by weight based on the dry weight of the oil phase.

In an aspect, the first multifunctional crosslinker is a first polyisocyanate, and the second multifunctional crosslinker, when present, is a second polyisocyanate, and the first polyisocyanate and the second polyisocyanate are different.

In an aspect, the first multifunctional crosslinker is a first polyisocyanate, and the second multifunctional crosslinker, when present, is a second polyisocyanate, and the first polyisocyanate and the second polyisocyanate are the same.

In an aspect, each of the first and second polyisocyanates has an average isocyanate functionality of 2 to 5.

In an aspect, each of the first and second polyisocyanates has an average isocyanate functionality of 3 to 4.

In an aspect, each of the first and second polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect, each of the first and second polyisocyanates is independently selected from a group consisting of DESMODUR® N-3300, DESMODUR® N-100, DESMODUR® Z4470SN, WANNATE® T series polyisocyanates, and LUPRANATE® M series polyisocyanates.

In an aspect, the first adduct has an average isocyanate functionality of 2 to 3.

In an aspect, the first adduct has an average isocyanate functionality of about 2.05 to about 2.3.

In an aspect, the reactive isocyanate functionality on the first adduct is protected with a blocking agent.

In an aspect, the blocking agent is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid.

In an aspect, the blocking agent is selected from a group consisting of acetone oxime, methyl ethyl ketone oxime, sodium bisulfite, diethyl malonate, and 3,5-dimethylpyrazole.

In an aspect, the antimicrobial composition further comprises a de-blocking agent.

In an aspect, the de-blocking agent is selected from a group consisting of organotin, organobismuth, and tert-amines.

In an aspect, the first adduct is present in the oil phase in an amount of about 15% to about 70% by weight based on the dry weight of the oil phase.

In an aspect, the oil phase further comprises an organic solvent or diluent.

In an aspect, the organic solvent or diluent in the oil phase is water miscible.

In an aspect, the organic solvent or diluent is acetone.

In an aspect, the organic solvent or diluent is present in the oil phase in an amount of about 5% to about 35% by weight based on the weight of the oil phase.

In an aspect, the organic solvent or diluent is present in the oil phase in an amount of about 10% to about 30% by weight based on the weight of the oil phase.

In an aspect, the polyol is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In an aspect, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In an aspect, the polyol has a weight average molecular weight from about 300 to about 3000.

In an aspect, the polyol has a weight average molecular weight from about 400 to about 2000.

In an aspect, the polyol has a weight average molecular weight from about 600 to about 1500.

In an aspect, the polyol is present in the oil phase in an amount of about 15% to about 60% by weight based on the dry weight of the oil phase.

In an aspect, the polyol is present in the oil phase in an amount of about 20% to about 40% by weight based on the dry weight of the oil phase.

In an aspect, the water-soluble polymer is selected from a group consisting of hydroxyethyl cellulose (HEC), hydroxypropyl cellulose, polyvinyl alcohol, poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyacrylamide, polyethylene imine, a copolymer of two or more thereof, a copolymer of one or more thereof with polyvinylpyrrolidone poly(glycidyl acrylate) or with poly(glycidyl methacrylate), and a combination or blend of two or more thereof.

In an aspect, the water-soluble polymer is hydroxyethyl cellulose or a hydrophobically modified derivative thereof.

In an aspect, the water-soluble polymer is a polyethylene imine.

In an aspect, the water-soluble polymer is present in the aqueous phase in amount of about 0.5% to about 15% by weight of the dry weight of the oil phase.

In an aspect, the water-soluble polymer is present in the aqueous phase in amount of about 3% to about 12% by weight of the dry weight of the oil phase.

In an aspect, the water-soluble polymer is present in the aqueous phase in amount of about 5% to about 10% by weight of the dry weight of the oil phase.

In an aspect, in the antimicrobial composition, the aqueous phase further comprises a surfactant.

In an aspect, the surfactant is a non-ionic surfactant.

In an aspect, the non-ionic surfactant has a HLB (hydrophilic-lipophilic balance) value of about 12 to about 15.

In an aspect, the non-ionic surfactant is selected from TRITON™ X-114 ((1,1,3,3-tetramethylbutyl)phenyl-polyethylene glycol), SILWET™ L-7604 (siloxane polyalkyleneoxide copolymer), and a combination thereof.

In an aspect, the surfactant is present in the aqueous phase in an amount of about 0.01% to about 2% by weight based on the dry weight of the oil phase.

In an aspect, the surfactant is present in the aqueous phase in an amount of about 0.1% to about 1% by weight based on the dry weight of the oil phase.

In an aspect, the aqueous phase further comprises a defoamer or antifoamer.

In an aspect, the defoamer is FOAMSTAR® ST 2410 (star polymer-based defoamer).

In an aspect, a random polymer or an interpenetrating polymer network is produced from random polymerization/crosslinking of the first adduct, the polyol, the water-soluble polymer, and, when present, the second multifunctional crosslinker.

In an aspect, the oil phase further comprises a second adduct of the first multifunctional crosslinker and a second quaternary ammonium salt

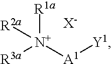

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

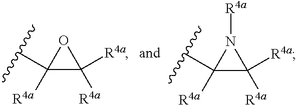

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from 0, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect, the oil phase further comprises a second adduct of a third multifunctional crosslinker and a second quaternary ammonium salt

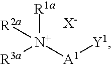

wherein
R^{1a}, R^{2a}, and R^{3a} are each independently methyl or ethyl;
A¹ is a linking group selected from a group consisting of —(C₃-C₂a alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂a heteroalkylene)- has 1 to 4 heteroatoms independently selected from 0, S, and Si; and —(C₃-C₂a alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

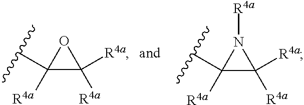

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from 0, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect, the third multifunctional crosslinker is different from the first multifunctional crosslinker and, when present, from the second multifunctional crosslinker.

In an aspect, the third multifunctional crosslinker is a third polyisocyanate.

In an aspect, the third polyisocyanate has an average isocyanate functionality of 2 to 5.

In an aspect, the third polyisocyanate is prepared from a diisocyanate selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect, the third polyisocyanate is selected from a group consisting of DESMODUR® N-3300, DESMODUR® N-100, DESMODUR® Z4470SN, WANNATE® T series polyisocyanates, and LUPRANATE® M series polyisocyanates.

In an aspect, the second quaternary ammonium salt is

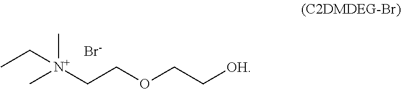

In an aspect, the second quaternary ammonium salt is present in the oil phase in an amount of about 1% to about 15% by weight based on the dry weight of the oil phase.

In an aspect, the second quaternary ammonium salt is present in the oil phase in an amount of about 3% to about 10% by weight based on the dry weight of the oil phase.

In an aspect, the second adduct has an average isocyanate functionality of 2 to 3.

In an aspect, the second adduct has an average isocyanate functionality of about 2.05 to about 2.3.

In an aspect, the second adduct is present in the oil phase in an amount of about 3% to about 40% by weight based on the dry weight of the oil phase.

In an aspect, a random polymer or an interpenetrating polymer network is produced from random polymerization/crosslinking of the first adduct, the second adduct, the polyol, the water-soluble polymer, and, when present, the second multifunctional crosslinker.

In an aspect, the oil phase further comprises a chain extender selected from a group consisting of HO—(CₙH₂ₙ)—OH and HO—(CₙH₂ₙ₋₂)—OH, or a combination thereof, wherein n is an integral between 2 and 8.

In an aspect, the chain extender is propanediol, 1,4-butanediol, neopentyl glycol, hexanediol, cyclohexane dimethanol, or a combination of two or more thereof.

In an aspect, the chain extender is present in the oil phase in an amount of up to about 10% by weight based on the dry weight of the oil phase.

In an aspect, the chain extender is present in the oil phase in an amount of about 1% to about 5% by weight based on the dry weight of the oil phase.

In an aspect, a random polymer or an interpenetrating polymer network is produced from random polymerization/crosslinking of the first adduct, the second adduct, the polyol, the chain extender, the water-soluble polymer, and, when present, the second multifunctional crosslinker.

In an aspect, provided is a polymer or interpenetrating polymer network comprising a random polymerization/crosslinking product of reagents comprising (i) a first adduct of a first multifunctional crosslinker and a first quaternary ammonium salt; (ii) a polyol; (iii) a water-soluble polymer; and (iv) optionally a second multifunctional crosslinker; wherein the water-soluble polymer comprises hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethylene imine, polyacrylamide, or a combination or blend of two or more thereof, or a copolymer of two or more thereof, or a copolymer of one or more thereof with polyvinylpyrrolidone, poly(glycidyl acrylate) or with poly(glycidyl methacrylate).

In an aspect, the water-soluble polymer is present in the dried polymer or interpenetrating polymer network in an amount of about 0.5 wt. % to about 15 wt. %.

In an aspect, in the polymer or interpenetrating polymer network, the first quaternary ammonium salt has a chemical structure of

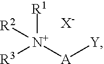

wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₃-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹—(CR^{p}R^{q})_{y11}H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl); —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl), —(CR^{m}Rⁿ)ₓ₃₀—W⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹ and W⁴¹ are independently selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴,

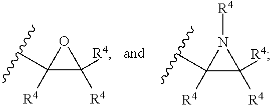

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect of the polymer or interpenetrating polymer network, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁₀ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from O, S, and Si.

In an aspect of the polymer or interpenetrating polymer network, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si.

In an aspect of the polymer or interpenetrating polymer network, R² and R³ are methyl.

In an aspect of the polymer or interpenetrating polymer network, A is —(CH₂)ₘ— or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In an aspect of the polymer or interpenetrating polymer network, R⁵ is H or methyl.

In an aspect of the polymer or interpenetrating polymer network, the first quaternary ammonium salt is

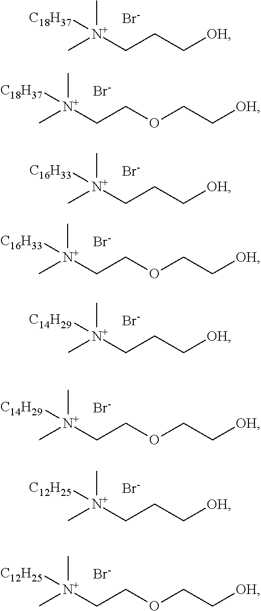

or a combination of two or more thereof.

In an aspect of the polymer or interpenetrating polymer network, the first quaternary ammonium salt is present in the dried polymer or interpenetrating polymer network in an amount of about 10 wt. % to about 50 wt. %.

In an aspect of the polymer or interpenetrating polymer network, the first multifunctional crosslinker is a first polyisocyanate, and the second multifunctional crosslinker, when present, is a second polyisocyanate, and the first polyisocyanate and the second polyisocyanate are different.

In an aspect of the polymer or interpenetrating polymer network, the first multifunctional crosslinker is a first polyisocyanate, and the second multifunctional crosslinker, when present, is a second polyisocyanate, and the first polyisocyanate and the second polyisocyanate are the same.

In an aspect of the polymer or interpenetrating polymer network, each of the first and second polyisocyanates has an average isocyanate functionality of 2 to 5.

In an aspect of the polymer or interpenetrating polymer network, each of the first and second polyisocyanates has an average isocyanate functionality of 3 to 4.

In an aspect of the polymer or interpenetrating polymer network, each of the first and second polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect of the polymer or interpenetrating polymer network, each of the first and second polyisocyanates is independently selected from a group consisting of DESMODUR® N-3300, DESMODUR® N-100, DESMODUR® Z4470SN, WANNATE® T series polyisocyanates, and LUPRANATE® M series polyisocyanates.

In an aspect of the polymer or interpenetrating polymer network, the first multifunctional crosslinker is present in the dried polymer or interpenetrating polymer network in an amount of about 5 wt. % to about 25 wt. %.

In an aspect of the polymer or interpenetrating polymer network, the second multifunctional crosslinker is present in the dried polymer or interpenetrating polymer network in an amount of about 5 wt. % to about 25 wt. %.

In an aspect of the polymer or interpenetrating polymer network, each of the first polyisocyanate and the first adduct has an average isocyanate functionality of 2 to 3.

In an aspect of the polymer or interpenetrating polymer network, each of the first polyisocyanate and the first adduct has an average isocyanate functionality of about 2.05 to about 2.3.

In an aspect of the polymer or interpenetrating polymer network, the polyol is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In an aspect of the polymer or interpenetrating polymer network, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In an aspect of the polymer or interpenetrating polymer network, the polyol has a weight average molecular weight from about 300 to about 3000.

In an aspect of the polymer or interpenetrating polymer network, the polyol has a weight average molecular weight from about 400 to about 2000.

In an aspect of the polymer or interpenetrating polymer network, the polyol has a weight average molecular weight from about 600 to about 1500.

In an aspect of the polymer or interpenetrating polymer network, the polyol is present in the dried polymer or interpenetrating polymer network in an amount of about 20 wt. % to about 40 wt. %.

In an aspect of the polymer or interpenetrating polymer network, the reagents further comprise a second adduct of the first multifunctional crosslinker and a second quaternary ammonium salt

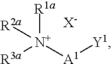

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

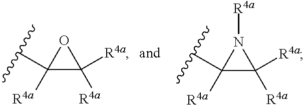

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁a aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect of the polymer or interpenetrating polymer network, the reagents further comprise a second adduct of a third multifunctional crosslinker and a second quaternary ammonium salt

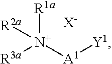

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from 0, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

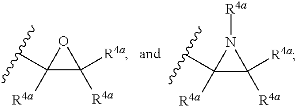

each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from 0, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In an aspect of the polymer or interpenetrating polymer network, the third multifunctional crosslinker is present in the dried polymer or interpenetrating polymer network in an amount of about 5 wt. % to about 25 wt. %.

In an aspect of the polymer or interpenetrating polymer network, the third multifunctional crosslinker is different from the first multifunctional crosslinker and, if present, from the second multifunctional crosslinker.

In an aspect of the polymer or interpenetrating polymer network, the third multifunctional crosslinker is a third polyisocyanate.

In an aspect of the polymer or interpenetrating polymer network, the third polyisocyanate is prepared from a diisocyanate selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In an aspect of the polymer or interpenetrating polymer network, the third polyisocyanate is selected from the group consisting of DESMODUR® N-3300, DESMODUR® N-100, DESMODUR® Z4470SN, WANNATE® T series polyisocyanates, and LUPRANATE® M series polyisocyanates.

In an aspect of the polymer or interpenetrating polymer network, the second quaternary ammonium salt is

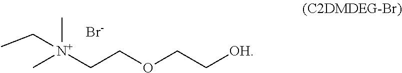

In an aspect of the polymer or interpenetrating polymer network, the second quaternary ammonium salt is present in the dried polymer or interpenetrating polymer network in an amount of about 1 wt. % to about 15 wt. %.

In an aspect of the polymer or interpenetrating polymer network, the second adduct has an average isocyanate functionality of 2 to 3.

In an aspect of the polymer or interpenetrating polymer network, the second adduct has an average isocyanate functionality of about 2.05 to about 2.3.

In an aspect of the polymer or interpenetrating polymer network, the reagents further comprise a chain extender selected from a group consisting of HO—(CₙH₂ₙ)—OH and HO—(CₙH₂ₙ₋₂)—OH, or a combination thereof, wherein n is an integral between 2 and 8.

In an aspect of the polymer or interpenetrating polymer network, the chain extender is propanediol, 1,4-butanediol, neopentyl glycol, hexanediol, cyclohexane dimethanol, or a combination of two or more thereof.

In an aspect of the polymer or interpenetrating polymer network, the chain extender is present in the dried polymer or interpenetrating polymer network in an amount of about 0.5 wt. % to about 10 wt. %.

In an aspect, a composition is provided comprising the polymer or interpenetrating polymer network described above.

In an aspect, an antimicrobial coating, coating fluid, or spraying fluid comprising the composition described above is provided.

In an aspect, a device, equipment, apparatus, or accessory is provided comprising the coating, the coating fluid or the spraying fluid described above.

In an aspect, the device, the equipment, the apparatus, or the accessory described above is provided, wherein the coating fluid or spraying fluid is water soluble or water dispersible.

In an aspect, the device, the equipment, the apparatus, or the accessory as described above is provided, wherein the device, equipment, apparatus, or accessory is selected from a group consisting of a filter, an air purifier, and a mask.

In an aspect, the device, the equipment, the apparatus, or the accessory described above is provided, wherein the device, equipment, apparatus, or accessory is selected from a group consisting of a keyboard, a keypad, a stylus, a mouse, a handheld device, a remote controller, a touch screen, a phone, a handheld device, and a display.

In an aspect, a personal care aid comprising the coating, the coating fluid, or the spraying fluid described above is provided.

In an aspect, the coating fluid or the spraying fluid is water soluble or water dispersible.

In an aspect, a method to sanitize a surface is provided, the method comprising applying the composition described above.

In an aspect, a method to reduce antimicrobial growth on a surface is provided, the method comprising applying the composition described above to the surface.

In an aspect, a method to prevent antimicrobial growth on a surface is provided, the method comprising applying the composition described above to the surface.

In an aspect, a method as described above further comprises forming a coating solution containing the composition.

In an aspect, the foregoing method further comprises directing the coating solution to a surface, and providing a coating on the surface through the application of the coating solution to the surface.

In an aspect, a polymer or interpenetrating polymer network is prepared by:
(a) reacting a first multifunctional crosslinker with a first quaternary ammonium salt to form a first adduct;
(b) optionally reacting the first multifunctional crosslinker or a third multifunctional crosslinker with a second quaternary ammonium salt to form a second adduct;
(c) combining the first adduct and, when present, the second adduct, with a polyol and optionally a second multifunctional crosslinker to form an oil phase;
(d) dissolving a water-soluble polymer in water to form an aqueous phase;
(e) combining the oil phase and the aqueous phase to form an oil-in-water emulsion; and
(f) applying the emulsion onto a surface and allowing the emulsion to dry and cure on the surface to form the polymer or interpenetrating polymer network on the surface.

In an aspect, a blocking agent is added to the oil phase after step (c) but before step (e).

In an aspect, step (c) further comprises combining the first adduct and, when present, the second adduct, with the polyol and optionally the second multifunctional crosslinker in an organic solvent or diluent to form the oil phase.

In an aspect, step (d) further comprises adding a chain extender to the oil phase or the aqueous phase.

In an aspect, step (d) further comprises adding a surfactant to the aqueous phase.

In an aspect, step (d) further comprises adding a defoamer or antifoamer to the aqueous phase.

In an aspect, step (d) further comprises adding a surfactant and either a defoamer or antifoamer to the aqueous phase.

In an aspect, step (e) further comprises performing a direct emulsification process whereby the emulsion is formed by vigorous shear and mixing.

In an aspect, step (e) further comprises performing a direct emulsification process whereby the emulsion is formed by sonication.

In an aspect, step (e) further comprises performing a phase inversion emulsification process whereby a water-in-oil emulsion is first prepared, followed by phase inversion to form the oil-in-water emulsion.

In an aspect, the phase inversion is conducted by changing the phase ratio, temperature, surfactant, solvent, or any combination of two or more thereof.

In another aspect, the present technology provides a personal care aid comprising any of the above-described coating, coating fluid or spraying fluid. In some embodiments, the coating fluid or spraying fluid is water soluble or water dispersible.

Other implementations are also described and recited herein.

### DETAILED DESCRIPTION

In the following description, for purposes of explanation, numerous specific details are set forth in order to provide a thorough understanding of the present technology. It may be evident, however, that the present technology may be practiced without these specific details. It is to be appreciated that certain aspects, modes, embodiments, variations and features of the technology are described below in various levels of detail in order to provide a substantial understanding of the present technology.

### Definitions

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed subject-matter, because the scope of the present technology is limited only by the claims. Unless otherwise defined, all technical and scientific terms used herein have the same meaning as commonly understood by one of ordinary skill in the art to which this present technology belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of additional elements that do not materially affect the basic and novel or functional characteristic(s) of that embodiment of the present technology.

As used herein, “aryl” refers to a carbocyclic (all carbon) ring that is fully aromatized. An “aryl” group can be made up of two or more fused rings (rings that share two adjacent carbon atoms). When an aryl group is a fused ring system, then the ring that is connected to the rest of the molecule is fully aromatized. The other ring(s) in the fused ring system may or may not be fully aromatized. Examples of aryl groups include, without limitation, the radicals of benzene, naphthalene and azulene.

As used herein, “alkyl” refers to a straight or branched chain fully saturated (no double or triple bonds) hydrocarbon group. An alkyl group of the presently disclosed compounds may comprise from 1 to 15 carbon atoms. An alkyl group herein may have 1 to 4 carbon atoms, 1 to 5 carbon atoms, 1 to 6 carbon atoms, 1 to 7 carbon atoms, 1 to 8 carbon atoms, 1 to 9 carbon atoms, 1 to 10 carbon atoms, 1 to 11 carbon atoms, 1 to 12 carbon atoms, 1 to 13 carbon atoms, 1 to 14 carbon atoms, or 1 to 15 carbon atoms. As used herein, a C₁-C₅ alkyl represents an alkyl group having 1 to 6 carbon atoms, a C₁-C₄ alkyl represents an alkyl group having 1 to 4 carbon atoms and a C₁-C₃ alkyl represents an alkyl group having 1 to 3 carbon atoms, etc. Examples of alkyl groups include, without limitation, methyl, ethyl, n-propyl, isopropyl, n-butyl, i-butyl, sec-butyl, t-butyl, amyl, t-amyl, hexyl, heptyl, octyl, nonyl, decyl, undecyl and dodecyl.

As used herein, “alkoxy” refers to an alkyl group, as defined above, appended to the parent molecular moiety through an oxy group, —O—. As used herein, a C₁-C₆ alkoxy represents an alkoxy group containing 1 to 6 carbon atoms and a C₁-C₃ alkoxy represents an alkoxy group containing 1 to 3 carbon atoms. Representative examples of alkoxy include, but are not limited to, methoxy, ethoxy, propoxy, 2-propoxy, butoxy, tert-butoxy, pentyloxy, hexyloxy etc.

As used herein, “cycloalkyl” refers to a monocyclic, bicyclic or polycyclic hydrocarbon ring system having, in some embodiments, 3 to 14 carbon atoms (e.g., C₃-C₁₄ cycloalkyl), or 3 to 10 carbon atoms (e.g., C₃-C₁₀ cycloalkyl), or 3 to 8 carbon atoms (e.g., C₃-C₈ cycloalkyl), or 3 to 6 carbon atoms (e.g., C₃-C₆ cycloalkyl) or 5 to 6 carbon atoms (e.g., C₅-C₆ cycloalkyl). Cycloalkyl groups can be saturated or characterized by one or more points of unsaturation (i.e., carbon-carbon double and/or triple bonds), provided that the points of unsaturation do not result in an aromatic system. Examples of monocyclic cycloalkyl groups include, but are not limited to, cyclopropyl, cyclobutyl, cyclopentyl, cyclohexyl, cyclohexeneyl, cyclohexynyl, cycloheptyl, cyclohepteneyl, cycloheptadieneyl, cyclooctyl, cycloocteneyl, cyclooctadieneyl and the like. The rings of bicyclic and polycyclic cycloalkyl groups can be fused, bridged, or spirocyclic.

As used herein, unless otherwise stated, “heteroalkyl” refers to an alkyl group, as defined herein, in which one or more of the constituent carbon atoms have been replaced by nitrogen, oxygen, sulfur, or silicon. A representative example of a heteroalkyl group is an alkoxy. A heteroalkylene is a divalent heteroalkyl group.

As used herein, unless otherwise stated, term “heteroaryl” refers to monocyclic or fused bicyclic aromatic groups (or rings) having, in some embodiments, from 5 to 14 (i.e., 5- to 14-membered heteroaryl), or from 5 to 10 (i.e., 5- to 10-membered heteroaryl), or from 5 to 6 (i.e., 5- to 6-membered heteroaryl) members (i.e., ring vertices), and containing from one to five, one to four, one to three, one to two or one heteroatom selected from nitrogen (N), oxygen (O), and sulfur (S). A heteroaryl group can be attached to the remainder of the molecule through a carbon atom or a heteroatom of the heteroaryl group, when chemically permissible. Non-limiting examples of heteroaryl groups include pyridyl, pyridazinyl, pyrazinyl, pyrimindinyl, triazinyl, purinyl, thienopyridinyl, thienopyrimidinyl, pyrazolopyrimidinyl, pyrazolopyridinyl, imidazopyridines, isothiazolyl, pyrazolyl, indazolyl, pteridinyl, imidazolyl, triazolyl, tetrazolyl, oxazolyl, isoxazolyl, thiadiazolyl, pyrrolyl, thiazolyl, furyl, thienyl and the like.

The term “heterocycloalkyl” refers to a non-aromatic monocyclic, bicyclic or polycyclic cycloalkyl ring having, in some embodiments, 3 to 14 members (e.g., 3- to 14-membered heterocycle), or 3 to 10 members (e.g., 3- to 10-membered heterocycle), or 3 to 8 members (e.g., 3- to 8-membered heterocycle), or 3 to 6 members (e.g., 3- to 6-membered heterocycle), or 5 to 6 members (e.g., 5- to 6-membered heterocycle), and having from one to five, one to four, one to three, one to two or one heteroatom selected from nitrogen (N), oxygen (O), sulfur (S) and silicon (Si). Heterocycloalkyl groups are saturated or characterized by one or more points of unsaturation (e.g., one or more carbon-carbon double bonds, carbon-carbon triple bonds, carbon-nitrogen double bonds, and/or nitrogen-nitrogen double bonds), provided that the points of unsaturation do not result in an aromatic system. The rings of bicyclic and polycyclic heterocycloalkyl groups can be fused, bridged, or spirocyclic. Non-limiting examples of heterocycloalkyl groups include aziridine, oxirane, thiirane, pyrrolidine, imidazolidine, pyrazolidine, dioxolane, phthalimide, piperidine, 1,4-dioxane, morpholine, thiomorpholine, thiomorpholine-S-oxide, thiomorpholine-S, S-oxide, piperazine, 3,4,5,6-tetrahydropyridazine, tetrahydropyran, pyran, decahydroisoquinoline, 3-pyrroline, thiopyran, tetrahydrofuran, tetrahydrothiophene, quinuclidine, and the like. A heterocycloalkyl group can be attached to the remainder of the molecule through a ring carbon atom, or a ring heteroatom, when chemically permissible.

As used herein, unless otherwise stated, “independently selected” indicates that each one of a designated group is selected independently from a subsequent list of species.

The term “statistically significant” or “significantly” refers to statistical significance and generally means a two standard deviation (2SD) or greater difference.

The terms “decrease”, “reduced”, “reduction”, or “inhibit” are all used herein to mean a decrease by a statistically significant amount. In some embodiments, “reduce,” “reduction” or “decrease” or “inhibit” typically means a decrease by at least 10% as compared to a reference level (e.g., the absence of a given treatment or agent) and can include, for example, a decrease by at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or more. As used herein, “reduction” or “inhibition” does not encompass a complete inhibition or reduction as compared to a reference level. “Complete inhibition” is a 100% inhibition as compared to a reference level. A decrease can be preferably down to a level accepted as within the range of normal for an individual without a given disorder.

The terms “increased”, “increase”, “enhance”, or “activate” are all used herein to mean an increase by a statically significant amount. In some embodiments, the terms “increased”, “increase”, “enhance”, or “activate” can mean an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level. In the context of a marker or symptom, an “increase” is a statistically significant increase in such level.

As used herein, the term “polyisocyanates” generally represents the family of polyisocyanates containing more than one isocyanate reactive group such as, but not limited to, DESMODUR® N3300 and N100 (made by Covestro Deutschland AG of Leverkusen, Germany) which are aliphatic polyisocyanates based on HDI (hexamethylene diisocyanate) trimer, DESMODUR® Z4470SN (made by Covestro Deutschland AG of Leverkusen, Germany) which is a multifunctional polyisocyanate based on IPDI (isophorone diisocyanate), WANNATE® T series polyisocyanates which are toluene diisocyanate (TDI)-based aromatic polyisocyanates, and LUPRANATE® M series polyisocyanates which are 4,4-diphenylmethane diisocyanate (MDI)-based aromatic polyisocyanates.

As used herein, the term “antimicrobial” is used generally to indicate at least some level of microbe kill by a composition or a coating on a portion of a surface. For example, antimicrobial may be used to indicate a biostatic efficacy, sanitizing level (3-log, or 99.9%) reduction in at least one organism, or a disinfection level (5-log, or 99.999%) reduction in at least one organism, or sterilization (no detectable organisms). Microbes, or microorganisms, may include any species of bacteria, virus, fungus including mold and yeast, or spore. Thus, antimicrobial herein encompasses antiviral, antibacterial and antifungal.

As used herein, the terms “residual antimicrobial,” “residual self-sanitizing,” and “self-decontaminating surface” are used interchangeably to indicate a surface that maintains antimicrobial efficacy over a certain period of time under certain conditions once the surface is coated with an antimicrobial coating composition and that composition dried on the surface as a thin film. A coated surface may maintain residual antimicrobial efficacy indefinitely, or the coating may eventually “wear out” and lose its residual antimicrobial efficacy. An antimicrobial coating composition may function as a contact sanitizer, bacteriostatic material, disinfectant, or sterilant, (e.g., as a liquid antimicrobial applied to a contaminated surface) and may also have the ability to leave behind a residual antimicrobial coating on the surface once dried or cured thereon that can keep inactivating new microorganisms that contact the coated surface. In various embodiments, coating compositions may not be antimicrobial until dried or cured on a surface but are still referred to as antimicrobial coating compositions because of their ability to produce a residual antimicrobial coating on a surface. Antimicrobial coating compositions for use in various embodiments may provide a residual antimicrobial efficacy to a surface, meaning that a microorganism later inoculated on, or that otherwise comes in contact with, the coated surface may experience cell death, destruction, or inactivation. The residual antimicrobial effect made possible by the coatings herein is not limited by a particular mechanism of action, and no such theories are proffered. For example, an antimicrobial effect measured on a surface may be the result of intracellular mutations, inhibition of certain cellular processes, rupture of a cell wall, or a nondescript inactivation of the organism, such as in the case of viruses. Other antimicrobial effects may include inhibiting the reproduction of an organism or inhibiting the organism's ability to accumulate into biofilms.

As used herein, the term “antimicrobial coating composition” refers to a chemical composition comprising at least one chemical species, which is used to produce a residual antimicrobial coating on a surface after the composition is applied and then either dried, allowed to dry, or cured in some manner. The term is also used for liquid compositions that may find use as a germicidal spray (disinfectant or sanitizer), since the composition could then go on to dry into an antimicrobial coating. The term is also extended to include a composition that may be applied sequentially (e.g., over or under) or contemporaneously with the application of an antimicrobial coating composition, such as to assist in bonding the residual antimicrobial coating to the surface, improve durability of the overall coating, and/or to provide a catalytic effect or some sort of potentiation or synergy with the residual antimicrobial coating comprising an antimicrobial active. For simplicity herein, each one of multiple compositions used sequentially or contemporaneously to produce an overall residual antimicrobial coating on a portion of a surface is referred to as an “antimicrobial coating composition,” even if one or more of the compositions used for coating has no identifiable antimicrobial activity or where the active agent is uncertain. An antimicrobial coating composition may comprise a neat, 100% active chemical species or may be a solution or suspension of a single chemical species in a solvent. In other aspects, a composition may comprise a complex mixture of chemical substances, some of which may chemically react (hydrolyze, self-condense, etc.) within the composition to produce identifiable or unidentifiable reaction products. For example, a monomeric chemical species in an antimicrobial coating composition may partially or fully polymerize or copolymerize, such as to produce polymers including homopolymer and copolymers with a distribution of molecular weight, comonomer ratio, or molecular architecture while in solution, prior to a coating process using that composition. In other embodiments, chemical constituents within an antimicrobial coating composition may chemically react, graft, or form an interpenetration network on the surface or interphase that the composition is applied to, such as while the composition is drying and concentrating on the surface or while the coating composition is cured by various methods. In various embodiments, a solution comprising a polymer distribution may polymerize or cure further, such as to longer chain lengths or forming a polymer network, while the solution dries on a surface. Antimicrobial coating compositions for use in various embodiments may further comprise any number and combination of inert excipients, such as for example, solvents, buffers, acids, alkali, surfactants, emulsifiers, stabilizers, UV absorbers, thickeners, free-radical initiators, fillers, pigments or colorants, catalysts, etc.

As used herein, the term “homopolymer” takes on its ordinary meaning in organic chemistry of a molecule having repeated and identical monomer units. For simplicity's sake, the term homopolymer herein includes each of the smaller oligomers, i.e., dimer, trimer, tetramer, dendrimers, dendrons, etc., unless specified otherwise. For example, a homopolymer distribution herein may include the dimer and above, or the trimer and above, as indicated. In some instances, a homopolymer chain length distribution may be well defined and characterized, and in other instances, the distribution may not be characterizable at all and may remain unknown. The term copolymer herein includes random copolymer, block copolymer, graft copolymer, interpolymer complex, interpenetration network, etc., and their blends.

As used herein, and unless otherwise indicated, the term “wt. %” takes on the ordinary meaning of percent (%) by weight of an ingredient in a chemical composition, based on the total weight of the composition “as made.” For example, an aqueous composition comprising 1 wt. % amine “based on the total weight of the composition” equates to a composition containing 99.0 grams water and 1.0 gram amine. Wt. % in a composition indicates the wt. % of active material, unless indicated otherwise. “As made” means that a written composition shows what was added to a mixing vessel, and not what might end up in the mixture after certain ingredients react, such as if an ingredient hydrolyzes or polymerizes.

Unless otherwise defined herein, scientific and technical terms used in connection with the present application shall have the meanings that are commonly understood by those of ordinary skill in the art to which this disclosure belongs. It should be understood that this present technology is not limited to the particular methodology, protocols, and reagents, etc., described herein and as such can vary. The terminology used herein is for the purpose of describing particular embodiments only and is not intended to limit the scope of the present technology, which is defined solely by the claims. Definitions of common terms in immunology and molecular biology can be found in The Merck Manual of Diagnosis and Therapy;³ The Encyclopedia of Molecular Cell Biology and Molecular Medicine;⁴ Molecular Biology and Biotechnology: a Comprehensive Desk Reference;⁵ Immunology;⁶ Janeway's Immunobiology;⁷ Lewin's Genes XI;⁸ Molecular Cloning: A Laboratory Manual.;⁹ Basic Methods in Molecular Biology;¹⁰ Laboratory Methods in Enzymology;¹¹ Current Protocols in Molecular Biology (CPMB);¹² Current Protocols in Protein Science (CPPS);¹³ and Current Protocols in Immunology (CPI).¹⁴

Other terms are defined herein within the description of the various aspects of the present technology.

### Antimicrobial Coatings

Surfaces of objects which are in direct or indirect contact with humans and animals are exposed to a high microbial load and have a demonstrable influence on the transmission of diseases and infections. The antimicrobial coatings of the present technology can be particularly useful because they can be applied to just about any surface and drastically reduce the microbial load. Surfaces that can be treated with antimicrobial coatings include, but are not limited to, interior and exterior building components such as handrails, fixtures, fixture knobs, pulling handles, and grips; parts such as faucet handles for kitchens, wash rooms, bathrooms, toilets, personal articles, telephones, computers, door handles, counters, furniture, walls, ticketing machines, high-touch areas (e.g., lounges of buildings, public means of payment, and public means of transport), and other tough-to-clean/access areas such as mechanicals and HVAC systems. Further, these coatings have applicability to medical devices and accessories, implants, and instruments, laboratory equipment, factories, water filtration equipment, hospitals, school/childcare facilities, airports, restaurants, gyms, etc.

Bacteria of particular concern include, but are not limited to, Staphylococcus aureus (Staph), Escherichia coli (E. coli), Methicillin-Resistant Staphylococcus aureus (MRSA) and Vancomycin-Resistant Enterococcus faecalis and Enterobacter aerogenes (VRE). Staph is a group of over 30 strains that cause many different types of infections, including skin infections, food and blood poisoning. Most strains of E. coli are not harmful but are part of the healthy bacterial flora in the human gut. However, some strains can cause various diseases, including pneumonia, urinary tract infections, diarrhea and meningitis. Some strains of E. coli can also cause nausea, vomiting and fever. MRSA is a type of bacterium that causes infections in different parts of the body. It is relatively more difficult to treat than most other strains of Staph because it is resistant to antibiotics. It can cause serious skin, bloodstream, lungs or urinary tract infections. VRE are a type of bacteria called Enterococci that have developed resistance to many antibiotics, especially Vancomycin as the name suggests. These bacteria can cause serious infections, especially in people who are already ill, weak, and/or immunocompromised. VRE may cause bloodstream infection (sepsis), urinary infection, pneumonia, heart infections (endocarditis), or meningitis.

Viruses of particular concern include, but are not limited to, influenza A and B viruses, respiratory syncytial virus, adenovirus, rhinovirus and coronaviruses (229E, HKU1, NL63, OC43, and, more recently, SARS-CoV-2) as these viruses have been demonstrated to have long survival periods on numerous surfaces. For example, in a recent study of airports,¹⁵ detection of pathogen viral nucleic acids demonstrated viral surface contamination at multiple sites associated with high touch rates and suggested a potential risk in standard passenger pathways at airport sites. These viruses can cause serious infections, especially in people who are already ill, weak, and/or immunocompromised.

In the chemical coatings industry, a 99.9% percent reduction in bacteria or virus translates to a three order of magnitude reduction in microbial risk (i.e., 3 log). However, there is a number of physical and chemical requirements that an antimicrobial coating should meet to be a fully effective and broadly applicable antiviral/antibacterial/antifungal agent and surface coating. These properties include:
1. Highly antimicrobial against a broad spectrum of viruses, bacteria, and fungi.
2. Very fast-acting; killing greater than 99.9% of viruses in a contact time of ten minutes or less and of bacteria after overnight.
3. Long lasting; maintaining a bacteria or virus killing efficiency of at least 98% after 100 days of storage under ambient conditions or after 72 hours of storage at 40° C./85% RH humidity.
4. Non-toxic and nonallergenic based on recognized standard test procedures.
5. No materials leached out over time or when exposed to typical liquids used for cleaning.
6. Visibly colorless and transparent as a surface coating.
7. Easy to apply as a water-based formulation to a wide range of surfaces and materials by painting, spraying, dipping or other commonly used application methods.
8. Durable surface coating that is resistant to delaminating from the surface or becoming visibly deteriorated by contact with water, alcohol and common solvents.
9. Easy and cost effective to produce from readily available materials.
10. Made by a synthesis that is versatile enabling a wide range of chemical variations to fine tune its properties (i.e., solubility, etc.) for a range of different applications.
   To the present inventors' knowledge there are no antimicrobial coatings available yet that meet most or all of these requirements. Many of the existing antimicrobial coatings tend to deteriorate with time and lose effectiveness as contamination is repeated.

Conventional coating products claiming to deliver antibacterial properties include PAINTGUARD/PAINTSHIELD® from the Sherwin Williams Company (Cleveland, Ohio); ALESTA® AM and ALESTA® Ralguard from Axalta (Philadelphia, PA) and SILVERSAN™ from PPG Industrial Coatings (Pittsburgh, PA). However, these products generally claim to be 99.9% effective, but take over 5 hours after application to reach their maximum efficiency. Further, existing solutions tend to degrade over time, so that their active performance goes below 90% after recontamination (i.e., repeated exposure to pathogens in combination with routine environmental exposure and/or scrubbing/cleaning over prolonged periods of time). At just 90% protection, bacteria and germs have the ability to grow and respire, eventually multiplying to the point where existing pathogens on the substrate layer will persist, thereby decreasing the efficacy of these coatings.

Antimicrobial polymers have been reported with embedded agents including metals like silver,¹⁶ but these suffer from the fact that the embedded antimicrobial agents can leach out over time, causing the polymer coating to lose its antimicrobial activity. Moreover, such formulations are not entirely satisfactory, as they only lead to a 3 log reduction that fails to completely inhibit regrowth of bacteria. This lack of effectiveness can probably be attributed to the fact that silver is used insufficient amounts and/or is unevenly dispersed throughout the composition, resulting in an inconsistent and, ultimately, ineffective distribution of anti-microbial particles within the composition/coating.

Park et al. (2006)¹⁷ reported antimicrobial active polymers made by reacting polyethyleneimine with a hydrophobic long chain hydrocarbon alkylating agent and then quaternization by methylation. Although these polymers have antibacterial and antiviral activity as surface coatings, the coatings are not colorless, and they are not durable and resistant to contact with water and other common solvents to which the surface may regularly come in contact.

Many have speculated that the antiviral activity of quaternary ammonium polymers is due to the interaction between the hydrophobic quaternary ammonium groups and the negatively charged membrane of the virus causing a disruption of the membrane which inactivates microorganisms such as viruses. In fact, the active ingredients in many of the commercially-available antiviral surface sprays are low molecular weight quaternary ammonium surfactant-like materials, which are assumed to act by this mechanism but that do not form long lasting durable surface coatings.

Researchers have reported acrylic or methacrylic co-polymers with quaternary ammonium functional groups that have antimicrobial activity^{18,19} but these do not produce durable water and solvent resistant coatings, and some have exhibited a level of toxicity.

Several researchers have reported antimicrobial polyurethane polymers bearing quaternary ammonium functional groups^{20,21,22} but these have a number of shortcomings. Some are water soluble and thereby not suitable for durable surface coatings. Others do not report testing the durability of coatings or the toxicity of the materials. Some are rather tedious to synthesize requiring somewhat expensive materials and as many as four synthetic steps including amine blocking and deblocking reactions.

Gao et al. (2007)²³ have reported the synthesis and antibacterial activity of polymers synthesized by alkylating polyethyleneimine with propyl epoxide and then quaternizing with benzyl chloride. These polymers are reported to be highly antibacterial with contact times as short as 4 minutes, but they are water soluble and thereby not suitable for producing a durable surface coating. Furthermore, testing against viruses and toxicity was not reported for these polymers.

While antimicrobial quaternary ammonium compounds and polymers are previously known, simple coatings of these materials either are not optically clear or not highly antimicrobial or not durable and simple steps to cross-link the coatings to achieve durability are insufficient to simultaneously achieve these properties.

### Polymers or Interpenetrating Polymer Networks of the Present Technology

The present technology provides water-based quaternary ammonium polymer structures and compositions and formulations thereof that meet virtually all of the requirements listed above.

In one aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) a polyol; (iii) a water-soluble polymer; and (iv) optionally a second multifunctional crosslinker. In some embodiments, the water-soluble polymer comprises, consists essentially of, or consists of hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethylene imine, polyacrylamide, or a combination or blend of two or more thereof, or a copolymer of two or more thereof, or a copolymer of one or more thereof with polyvinylpyrrolidone, poly(glycidyl acrylate) or with poly(glycidyl methacrylate).

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) a polyol; (iii) a water-soluble polymer; and (iv) optionally a second multifunctional crosslinker, wherein the water-soluble polymer comprises, consists essentially of, or consists of hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethylene imine, polyacrylamide, or a combination or blend of two or more thereof, or a copolymer of two or more thereof, or a copolymer of one or more thereof with polyvinylpyrrolidone, poly(glycidyl acrylate) or with poly(glycidyl methacrylate).

The water-soluble polymer may be present in the dried polymer or interpenetrating polymer network in an amount of from about 0.5 wt. % to about 15 wt. %. This includes about 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 wt. %, or any value therebetween. In some embodiments, the water-soluble polymer is present in the dried polymer or interpenetrating polymer network in an amount of from about 0.5 wt. % to about 15 wt. %, about 3 wt. % to about 12 wt. %, or about 5 wt. % to about 10 wt. %.

The first quaternary ammonium salt may have a chemical structure of:

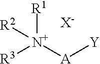

wherein:
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₁-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹—(CR^{p}R^{q})_{y11}H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl); —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl), —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene), —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰ and W⁴⁰ are independently selected from —C(O)—; —C(O)O—; —OC(O)—; —C(O)NH—; and —NHC(O)—;
W¹¹, W²¹, W³¹ and W⁴¹ are independently selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴,

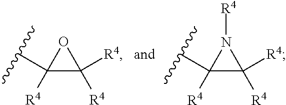

each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from 0, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

In some embodiments, R¹ is selected from a group consisting of —(C₁₂-C₃₀ alkyl), —(C₁₂-C₃₀ heteroalkyl), —(C₁₂-C₃₀ alkyl)-(C₆-C₁₀ aryl), —(C₁₂-C₃₀ heteroalkyl)-(C₆-C₁₀ aryl), —(C₆-C₁₀ aryl)-(C₁₂-C₃₀ alkyl), and —(C₆-C₁₀ aryl)-(C₁₂-C₃₀ heteroalkyl); wherein —(C₁₂-C₃₀ heteroalkyl), —(C₁₂-C₃₀ heteroalkyl)-(C₆-C₁₀ aryl), and —(C₆-C₁₀ aryl)-(C₁₂-C₃₀ heteroalkyl) have 1 to 4 heteroatoms independently selected from 0, S, and Si. In some embodiments, R¹ is —(C₁₂-C₃₀ alkyl). In some embodiments, R¹ is —(C₈-C₃₀ heteroalkyl) with 1 to 4 heteroatoms independently selected from 0, S, and Si. In some embodiments, R¹ is —(C₆-C₁₀ aryl)-(C₁₂-C₃₀ alkyl). In some embodiments, R¹ is —(C₁₂-C₃₀ alkyl)-(C₆-C₁₀ aryl). In some embodiments, R¹ is —(C₆-C₁₀ aryl)-(C₁₂-C₃₀ heteroalkyl) with 1 to 4 heteroatoms independently selected from 0, S, and Si. In some embodiments, R¹ is —(C₁₂-C₃₀ heteroalkyl)-(C₆-C₁₀ aryl) with 1 to 4 heteroatoms independently selected from O, S, and Si. In some embodiments, R¹ is —(CR^{m}Rⁿ)ₓ₁₀—W¹⁰—(CR^{p}R^{q})_{y10}—H. In some embodiments, R¹ is —(CR^{m}Rⁿ)ₓ₁—W¹¹—(CR^{p}R^{q})_{y11}—H.

In some embodiments, R² is —(C₁-C₄ alkyl). In some embodiments, R² is —(C₁-C₄ heteroalkyl) with 1 to 4 heteroatoms independently selected from O, S, and Si. In some embodiments, R² is —(C₆-C₁₀ aryl)-(C₁-C₄ alkyl). In some embodiments, R² is —(C₁-C₄ alkyl)-(C₆-C₁₀ aryl). In some embodiments, R² is —(C₆-C₁₀ aryl). In some embodiments, R² is —(C₆-C₁₀ aryl)-(C₁-C₄ heteroalkyl) with 1 to 4 heteroatoms independently selected from O, S, and Si. In some embodiments, R² is —(C₁-C₄ heteroalkyl)-(C₆-C₁₀ aryl) with 1 to 4 heteroatoms independently selected from O, S, and Si. In some embodiments, R² is —(CR^{m}Rⁿ)ₓ₂₀—W²⁰—(CR^{p}R^{q})_{y20}—H. In some embodiments, R² is —(CR^{m}Rⁿ)ₓ₂₁—W²¹—(CR^{p}R^{q})_{y21}—H.

In some embodiments, R³ is selected from a group consisting of —(C₁-C₄ alkyl), —(C₁-C₄ heteroalkyl), —(C₁-C₄ alkyl)-(C₆-C₁₀ aryl), —(C₁-C₄ heteroalkyl)-(C₆-C₁₀ aryl), —(C₆-C₁₀ aryl)-(C₁-C₄ alkyl), and —(C₆-C₁₀ aryl)-(C₁-C₄ heteroalkyl); wherein —(C₁-C₄ heteroalkyl), —(C₁-C₄ heteroalkyl)-(C₆-C₁₀ aryl), and —(C₆-C₁₀ aryl)-(C₁-C₄ heteroalkyl) have 1 to 4 heteroatoms independently selected from O, S, and Si. In some embodiments, R³ is —(C₁-C₄ alkyl). In some embodiments, R³ is —(C₁-C₄ heteroalkyl) with 1 to 4 heteroatoms independently selected from O, S, and Si. In some embodiments, R³ is —(C₆-C₁₀ aryl)-(C₁-C₄alkyl). In some embodiments, R³ is —(C₁-C₄ alkyl)-(C₆-C₁₀ aryl). In some embodiments, R³ is —(C₆-C₁₀ aryl)-(C₁-C₄ heteroalkyl) with 1 to 4 heteroatoms independently selected from O, S, and Si. In some embodiments, R³ is —(C₁-C₄ heteroalkyl)-(C₆-C₁₀ aryl) with 1 to 4 heteroatoms independently selected from O, S, and Si. In some embodiments, R³ is —(CR^{m}Rⁿ)ₓ₃₀—W³⁰—(CR^{p}R^{q})_{y30}—H. In some embodiments, R³ is —(CR^{m}Rⁿ)ₓ₃₁—W³¹—(CR^{p}R^{q})_{y31}—H.

In some embodiments, R² and R³ are methyl. In some embodiments, R¹ is C₁₂-C₃₀ alkyl, and R² and R³ are methyl.

In some embodiments, A is —(C₃-C₂₀ alkylene)- optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl). In some embodiments, A is —(C₃-C₂₀ heteroalkylene)- with 1 to 4 heteroatoms independently selected from O, S, and Si, and optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₅-C₁₀ aryl), —(C₁-C₃ heteroalkyl)-(C₆-C₁₀ aryl), and —(C₆-C₁₀ aryl). In some embodiments, A is —(C₆-C₁₀ arylene)-(C₃-C₂₀ alkylene)-. In some embodiments, A is —(C₃-C₂₀ alkylene)-(C₆-C₁₀ arylene)-.

In some embodiments, A is —(CR^{m}Rⁿ)ₓ₄₀—W⁴⁰—(CR^{p}R^{q})_{y40}—. In some embodiments, A is —(CR^{m}Rⁿ)ₓ₄₁—W⁴¹—(CR^{p}R^{q})_{y41}—.

In some embodiments, A is —(CH₂)ₘ— or —(CH₂CHR⁵—O—)ₙCH₂CHR⁵—, wherein m is an integer from 2 to 20; n is 0, 1, 2, 3, 4, or 5; and each R⁵ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, R⁵ is H or methyl.

In some embodiments, Y is —OH. In some embodiments, Y is —NHR⁴. In some embodiments, Y is —SH. In some embodiments, Y is —CO₂H. In some embodiments, Y is —C(O)NHR⁴, wherein R⁴ is selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, Y is —C(S)NHR⁴, wherein R⁴ is selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si. In some embodiments, Y is

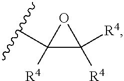

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

In some embodiments, Y is

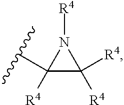

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

X⁻ may be independently selected from the group consisting of acetate, halide, sulfate, sulfonate, phosphate, phosphonate, carbonate, silicate, hexafluorophosphate, hexafluoroantimonate, and borate, and their organo-substituted derivatives. As used herein, and unless stated otherwise, “organo-substituted derivatives” refers to anions wherein a sulfur atom, a phosphorous atom, a boron atom, a silicon atom or carbonyl group is substituted with either an alkyl or an aryl group. Non-limiting examples include methylsulfate, methanesulfonate, p-toluene sulfonate, trifluoromethylsulfonate, and trifluoroacetate.

In some embodiments, the first quaternary ammonium salt is

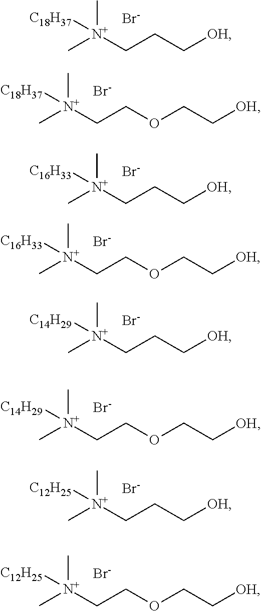

or a combination of two or more thereof.

The first quaternary ammonium salt may be present in the dried polymer or interpenetrating polymer network in an amount of about 10 wt. % to about 50 wt. %. This includes about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. %, or any value therebetween. In some embodiments, the first quaternary ammonium salt is present in the dried polymer or interpenetrating polymer network in an amount of about 15 wt. % to about 40 wt. %. In some embodiments, the first quaternary ammonium salt is present in the dried polymer or interpenetrating polymer network in an amount of about 20 wt. % to about 35 wt. %. More precisely, the amount of quaternary ammonium salt may be represented by millinormal/g (mN/g) instead of wt. % based on the total weight of the dried polymer or interpenetrating polymer network. The first quaternary ammonium salt may be present in the dried polymer or interpenetrating polymer network in an amount of from about 0.3 mN/g to about 1.0 mN/g. This includes 0.3, 0.4, 0.5, 0.6, 0.7, 0.8, 0.9, or 1.0 mN/g, or any value therebetween. In some embodiments, the first quaternary ammonium salt is present in the dried polymer or interpenetrating polymer network in an amount of from about 0.4 mN/g to about 0.9 mN/g. In some embodiments, the first quaternary ammonium salt is present in the dried polymer or interpenetrating polymer network in an amount of from about 0.5 mN/g to about 0.8 mN/g.

The first multifunctional crosslinker may be a first polyisocyanate. In some embodiments, the first polyisocyanate has an average isocyanate functionality of 2 to 5. This includes an average isocyanate functionality of 2, 3, 4, or 5. In some embodiments, the first polyisocyanate has an average isocyanate functionality of 3 to 4.

The second multifunctional crosslinker may be a second polyisocyanate. In some embodiments, the second polyisocyanate has an average isocyanate functionality of 2 to 5. This includes an average isocyanate functionality of 2, 3, 4, or 5. In some embodiments, the second polyisocyanate has an average isocyanate functionality of 3 to 4.

In some embodiments, the first multifunctional crosslinker is a first polyisocyanate, and the second multifunctional crosslinker, when present, is a second polyisocyanate, wherein the first polyisocyanate and the second polyisocyanate are different. In some embodiments, the first multifunctional crosslinker is a first polyisocyanate, and the second multifunctional crosslinker, when present, is a second polyisocyanate, wherein the first polyisocyanate and the second polyisocyanate are the same.

One or both of the first and second polyisocyanates may be prepared from diisocyanates independently selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In some embodiments, one or both of the first and second polyisocyanates is independently selected from the group consisting of DESMODUR® N-3300, DESMODUR® N-100, DESMODUR® Z4470SN, WANNATE® T series polyisocyanates, and LUPRANATE® M series polyisocyanates. DESMODUR® N-3300 and DESMODUR® N-100 are aliphatic polyisocyanates based on HDI (hexamethylene diisocyanate) trimer. DESMODUR® Z4470SN is a multifunctional polyisocyanate based on IPDI (isophorone diisocyanate). WANNATE® T series polyisocyanates are toluene diisocyanate (TDI)-based aromatic polyisocyanates. LUPRANATE® M series polyisocyanates are 4,4-diphenylmethane diisocyanate (MDI)-based aromatic polyisocyanates.

The first multifunctional crosslinker may be present in the dried polymer or interpenetrating polymer network in an amount of about 5 wt. % to about 25 wt. %. This includes 5, 6, 7, 8, 9, 10, 11, 12, 13, 14, 15, 16, 17, 18, 19, 20, 21, 22, 23, 24, or 25 wt. %, or any value therebetween. In some embodiments, the first multifunctional crosslinker is present in the dried polymer or interpenetrating polymer network in an amount of about 7 wt. % to about 15 wt. %, or about 5 wt. % to about 20 wt. %.

The second multifunctional crosslinker may be present in the dried polymer or interpenetrating polymer network in an amount of about 5 wt. % to about 25 wt. %, This includes 5, 6, 7, 8, 9, 10, 11, 12, 13, 14, 15, 16, 17, 18, 19, 20, 21, 22, 23, 24, or 25 wt. %, or any value therebetween. In some embodiments, the second multifunctional crosslinker is present in the dried polymer or interpenetrating polymer network in an amount of about 10 wt. % to about 20 wt. %, or about 5 wt. % to about 20 wt. %.

In some embodiments, the first adduct has an average isocyanate functionality of 2 to 3. In some embodiments, the first adduct has an average isocyanate functionality of about 2.05 to about 2.3.

The polyol may be selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

In some embodiments, the polyol comprises, consists essentially of, or consists of polytetramethylene glycol (PTMG), polyethylene glycol (PEG), polypropylene glycol (PPG), or a combination of two or more thereof, or a copolymer of one or more thereof with polyester, polycaprolactone, polybutadiene, poly(acrylonitrile-butadiene), polysiloxane, or polyacrylate. In some embodiments, the polyol is selected from a group consisting of poly(tetramethylene glycol), polyethylene glycol, polypropylene glycol, poly(ethylene glycol-b-propylene glycol-b-ethylene glycol), and poly(propylene glycol-b-polyethylene glycol-b-propylene glycol).

In some embodiments, the polyol comprises, consists essentially of, or consists of a polyether polyol, a polyester polyol, or a combination thereof.

The polyol may have an average molecular weight of about 300 to about 3000 daltons. This includes about 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 daltons, or any value therebetween. In some embodiments, the polyol has an average molecular weight of about 400 to about 2000, or about 600 to about 1500 daltons.

The polyol may be present in the dried polymer or interpenetrating polymer network in an amount of about 15 wt. % to about 60 wt. %. This includes 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt. %, or any value therebetween. In some embodiments, the polyol is present in the dried polymer or interpenetrating polymer network in an amount of about 20 wt. % to about 40 wt. %.

In some embodiments, the polyol is pre-reacted with the second polyisocyanate to form an isocyanate end-capped prepolymer.

The reagents may further comprise a second adduct of (i) the first multifunctional crosslinker or a third multifunctional crosslinker; and (ii) a second quaternary ammonium salt

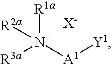

wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂₀ alkylene), —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from 0, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a},

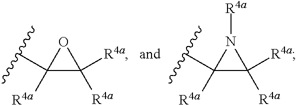

each R^{4a} is independently selected from a group consisting of H, (C—(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from 0, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

The third multifunctional crosslinker may be present in the dried polymer or interpenetrating polymer network in an amount of about 5 wt. % to about 25 wt. %. This includes 5, 6, 7, 8, 9, 10, 11, 12, 13, 14, 15, 16, 17, 18, 19, 20, 21, 22, 23, 24, or 25 wt. %, or any value therebetween. In some embodiments, the third multifunctional crosslinker is present in the dried polymer or interpenetrating polymer network in an amount of about 7 wt. % to about 15 wt. %, or about 5 wt. % to about 20 wt. %.

The third multifunctional crosslinker may be different from the first multifunctional crosslinker and, if present, from the second multifunctional crosslinker.

In some embodiments, the third multifunctional crosslinker is a third polyisocyanate. In some embodiments, the third polyisocyanate is prepared from a diisocyanate selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI). In some embodiments, the third polyisocyanate is selected from the group consisting of DESMODUR® N-3300, DESMODUR® N-100, DESMODUR® Z4470SN, WANNATE® T series polyisocyanates, and LUPRANATE® M series polyisocyanates.

In some embodiments, the second quaternary ammonium salt is

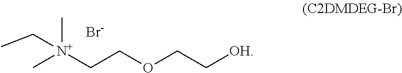

The second quaternary ammonium salt may be present in the dried polymer or interpenetrating polymer network in an amount of about 1 wt. % to about 15 wt. %. This includes about 1, 2, 3, 4, 5, 6, 7, 8, 9, 10, 11, 12, 13, 14, or 15 wt. %, or any value therebetween.

In some embodiments, the second adduct has an average isocyanate functionality of 2 to 3. In some embodiments, the second adduct has an average isocyanate functionality of 2.05 to about 2.3.

The reagents may further comprise a chain extender selected from a group consisting of HO—(CₙH₂ₙ)—OH and HO—(CₙH₂ₙ₋₂)—OH, or a combination thereof, wherein n is an integral between 2 and 8. In some embodiments, the chain extender is propanediol, 1,4-butanediol, neopentyl glycol, hexanediol, cyclohexane dimethanol, or a combination of two or more thereof. The chain extender may be present in the dried polymer or interpenetrating polymer network in an amount of about 0.5 wt. % to about 10 wt. %. This includes about 0.5, 1, 2, 3, 4, 5, 6, 7, 8, 9, or 10 wt. %, or any value therebetween.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) a polyol; (iii) a water-soluble polymer; (iv) optionally a second multifunctional crosslinker; (v) optionally a second adduct of (a) the first multifunctional crosslinker or a third multifunctional crosslinker, and (b) a second quaternary ammonium salt; and (vi) optionally a chain extender.

In another aspect, provided herein is a polymer or interpenetrating polymer network comprising a random polymerization/crosslinking product of reagents comprising, consisting essentially of, or consisting of (i) a first adduct of a first multifunctional crosslinker and a first quaternary ammonium salt; (ii) a polyol; (iii) a water-soluble polymer; (iv) optionally a second multifunctional crosslinker; (v) optionally a second adduct of (a) the first multifunctional crosslinker or a third multifunctional crosslinker, and (b) a second quaternary ammonium salt; and (vi) optionally a chain extender, wherein the water-soluble polymer comprises, consists essentially of, or consists of hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethylene imine, polyacrylamide, or a combination or blend of two or more thereof, or a copolymer of two or more thereof, or a copolymer of one or more thereof with polyvinylpyrrolidone, poly(glycidyl acrylate) or with poly(glycidyl methacrylate).

In some embodiments, a first quaternary ammonium salt reacts with a first polyisocyanate to form a first adduct, wherein the first adduct retains unreacted isocyanate functionality from the first polyisocyanate. In some embodiments, about 10% to about 40%, preferably about 25% to about 33% of isocyanate functionality on the first polyisocyanate is converted to, for example, urethane or urea by reaction with the first quaternary ammonium salt. The unreacted isocyanate functionality subsequently reacts with one or more of the polyol, the chain extender (if present), water, and the water-soluble polymer (if reactive). Similarly, in some embodiments, the second quaternary ammonium salt reacts with the first polyisocyanate or a third polyisocyanate to form a second adduct, wherein the second adduct retains unreacted isocyanate functionality from the first or third polyisocyanate. In some embodiments, about 10% to about 40%, preferably about 25% to 33% of isocyanate functionality on the first polyisocyanate is converted to, for example, urethane or urea by reaction with the second quaternary ammonium salt. If present, the second multifunctional crosslinker and/or second adduct may also react with one or more of the polyol, the chain extender (if present), water, and the water-soluble polymer (if reactive). The first adduct and the second adduct are pre-formed prior to interact with the polyol, the chain extender (if present), and the water-soluble polymer.

In another aspect, a polymer or interpenetrating polymer network is prepared by
(a) reacting a first multifunctional crosslinker with a first quaternary ammonium salt to form a first adduct;
(b) optionally reacting the first multifunctional crosslinker or a third multifunctional crosslinker with a second quaternary ammonium salt to form a second adduct;
(c) combining the first adduct and, when present, the second adduct, with a polyol and optionally a second multifunctional crosslinker to form an oil phase;
(d) dissolving a water-soluble polymer in water to form an aqueous phase;
(e) combining the oil phase and the aqueous phase to form an oil-in-water emulsion; and
(f) applying the emulsion onto a surface and allowing the emulsion to dry and cure on the surface to form the polymer or interpenetrating polymer network on the surface.

In some embodiments, a blocking agent is added to the oil phase after step (c) but before step (e).

In some embodiments, step (c) further comprises combining the first adduct and, when present, the second adduct, with the polyol and optionally the second multifunctional crosslinker in an organic solvent or diluent to form the oil phase.

In some embodiments, step (d) further comprises adding a chain extender to the oil phase or aqueous phase.

In some embodiments, step (d) further comprises adding a surfactant to the aqueous phase. In some embodiments, step (d) further comprises adding a defoamer or antifoamer to the aqueous phase. In some embodiments, step (d) further comprises adding a surfactant and either a defoamer or antifoamer to the aqueous phase.

In some embodiments, step (e) further comprises performing a direct emulsification process whereby the emulsion is formed by vigorous shear and mixing. In some embodiments, step (e) further comprises performing a direct emulsification process whereby the emulsion is formed by sonication.

In some embodiments, step (e) further comprises performing a phase inversion emulsification process whereby a water-in-oil emulsion is first prepared, followed by phase inversion to form the oil-in-water emulsion. The phase inversion may be conducted by, for example, changing the phase ratio, temperature, surfactant, solvent, or any combination of two or more thereof.

In some embodiments, a multiphase water-in-oil-in-water emulsion is formed prior to conversion to the oil-in-water emulsion in step (e).

In some embodiments, combining the oil phase and the aqueous phase in step (e) forms a combination of the oil-in-water emulsion and a multiphase water-in-oil-in-water emulsion.

In another aspect, reagents for the preparation of a polymer or interpenetrating polymer network described herein are comprised in an antimicrobial composition.

Accordingly, in another aspect, provided herein is an antimicrobial composition comprising an oil-in-water emulsion, wherein the oil-in-water emulsion comprises
(i) an oil phase comprising
   a first adduct of a first multifunctional crosslinker and a first quaternary ammonium salt, wherein the first quaternary ammonium salt has a reactive linking group to react with the first multifunctional crosslinker;
   a polyol; and
   optionally a second multifunctional crosslinker; and
(ii) an aqueous phase comprising a water-soluble polymer.
   This composition may be applied to a surface and allowed to dry and cure, thereby forming a polymer or interpenetrating polymer network of the present technology.

The water-soluble polymer may be a reactive water-soluble polymer and crosslinks with one or both of the first adduct and the second multifunctional crosslinker. In some embodiments, the water-soluble polymer is a reactive water-soluble polymer and crosslinks with the first adduct, the second multifunctional crosslinker (if present), or the second adduct (if present), or any combination of two or more thereof.

The reactive linking group of the first quaternary ammonium salt may be selected from a group consisting of —OH, —NHR⁴, —SH, —CO₂H, —C(O)NHR⁴, —C(S)NHR⁴,

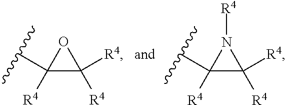

wherein each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si.

The first quaternary ammonium salt, incorporated into the first adduct, may be present in the oil phase in an amount of about 10% to about 50% by weight based on the dry weight of the oil phase. As used herein, and unless otherwise indicated, “dry weight of the oil phase” refers to weight of the oil phase in the absence of any organic solvent and any water. This includes about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%, or any value therebetween. In some embodiments, the first quaternary ammonium salt, incorporated into the first adduct, is present in the oil phase in an amount of about 15% to about 35%, or about 20% to about 30% by weight based on the dry weight of the oil phase.

The first multifunctional crosslinker (e.g., the first polyisocyanate), incorporated into the first adduct, may be present in the oil phase in an amount of about 5% to about 25% by weight based on the dry weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, or 25%, or any value therebetween. In some embodiments, the first multifunctional crosslinker (e.g., the first polyisocyanate), incorporated into the first adduct, is present in the oil phase in an amount of about 5% to about 20% by weight based on the dry weight of the oil phase.

The second multifunctional crosslinker (e.g., the second polyisocyanate) may be present in the oil phase in an amount of about 5% to about 25% by weight based on the dry weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%, or any value therebetween. In some embodiments, the second multifunctional crosslinker (e.g., the second polyisocyanate) is present in the oil phase in an amount of about 5% to about 20% by weight based on the dry weight of the oil phase.

In some embodiments, reactive isocyanate functionality on the first adduct and/or the second adduct is protected with a blocking agent. Reaction with the blocking agent converts the reactive isocyanate functionality to blocked isocyanates (i.e., the isocyanate group is reversibly protected from immediate reaction with a nucleophile). This decreases the rate of polyisocyanate reaction with water in a subsequent emulsification step and/or the cross-linking reaction with, for example, any polyol(s) in the oil phase and/or the water-soluble polymer (such as hydroxyethyl cellulose) in the aqueous phase. In some embodiments, there is significant improvement in the reproducibility of the rheology properties, particle size and distribution of the resultant emulsion. In some embodiments, the coatability and process window of the coating process are also significantly improved. In some embodiments, the defect rate of resultant surface coatings is reduced and the yield rate of coated products is also improved. In some embodiments, no blocking agent is used in order to provide a more rapidly curing coating.

In some embodiments, the blocking agent is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid. In some embodiments, the blocking agent is selected from a group consisting of acetone oxime, methyl ethyl ketone oxime, sodium bisulfite, diethyl malonate, and 3,5-dimethylpyrazole.

In some embodiments, the composition further comprises a de-blocking agent. The de-blocking agent includes, but is not limited to, organotin, organobismuth, and tert-amines. Non-limiting examples include triethanolamine; N,N,N′N′-tetrakis(2-hydroxyethyl) ethylene diamine; and K-KAT XK-651 (bismuth carboxylate catalyst).

The first adduct may be present in the oil phase in an amount of about 15% to about 70% by weight based on the dry weight of the oil phase. This includes about 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70%, or any value therebetween. In some embodiments, the first adduct is present in an amount of about 15% to about 65%, about 15% to about 60%, about 15% to about 50%, about 20% to about 70%, about 20% to about 60%, or about 20% to about 50%, by weight based on the dry weight of the oil phase.

In some embodiments, the oil phase further comprises a second adduct as described herein. The second adduct may be present in the oil phase in an amount of about 3% to about 40% by weight based on the dry weight of the oil phase. This includes about 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40%, or any value therebetween.

In some embodiments, the second quaternary ammonium salt, incorporated into the second adduct, is present in the oil phase in an amount of about 1% to about 15% by weight based on the dry weight of the oil phase. This includes about 1%, 2%, 3%, 4%, 5%, 6%, 7%, 8%, 9%, 10%, 11%, 12%, 13%, 14%, or 15%, or any value therebetween. In some embodiments, the second quaternary ammonium salt, incorporated into the second adduct, is present in the oil phase in an amount of about 3% to about 10% by weight based on the dry weight of the oil phase.

The third multifunctional crosslinker (e.g., the third polyisocyanate), incorporated into the second adduct, may be present in the oil phase in an amount of about 5% to about 25% by weight based on the dry weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, or 25%, or any value therebetween. In some embodiments, the third multifunctional crosslinker (e.g., the third polyisocyanate), incorporated into the second adduct, is present in the oil phase in an amount of about 5% to about 20% by weight based on the dry weight of the oil phase.

In some embodiments, the oil phase further comprises a chain extender selected from a group consisting of HO—(CₙH₂ₙ)—OH and HO—(CₙH₂ₙ₋₂)—OH, or a combination thereof, wherein n is an integral between 2 and 8. In some embodiments, the chain extender is propanediol, 1,4-butanediol, neopentyl glycol, hexanediol, cyclohexane dimethanol, or a combination of two or more thereof. The chain extender may be present in the oil phase in an amount of up to about 10% by weight based on the dry weight of the oil phase. This includes about 0.5%, 1%, 2%, 3%, 4%, 5%, 6%, 7%, 8%, 9%, 10%, or any value therebetween. In some embodiments, the chain extender is present in the oil phase in an amount of about 0.5% to about 10%, or about 1% to about 5% by weight based on the dry weight of the oil phase.

In some embodiments, the oil phase further comprises an organic solvent or diluent. In some embodiments, the organic solvent or diluent in the oil phase is water miscible. In some embodiments, the organic solvent or diluent is acetone. In some embodiments, the organic solvent or diluent is present in the oil phase in an amount of about 5% to about 35% by weight based on the weight of the oil phase. This includes about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, or 35%, or any value therebetween. In some embodiments, the organic solvent or diluent is present in the oil phase in an amount of about 10% to about 30% by weight based on the weight of the oil phase.

The polyol may be present in the oil phase in an amount of about 15% to about 60% by weight based on the dry weight of the oil phase. This includes about 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60%, or any value therebetween. In some embodiments, the polyol is present in the oil phase in an amount of about 20% to about 40% by weight based on the dry weight of the oil phase.

Weight percentage of the water-soluble polymer in the aqueous phase is calculated by the amount present in the oil phase for interaction with the oil phase itself and/or oil phase constituents (e.g., the first adduct, the optional second multifunctional crosslinker). The water-soluble polymer may be present in the aqueous phase in amount of about 0.5% to about 15% by weight of the dry weight of the oil phase. This includes about 0.5%, 1%, 2%, 3%, 4%, 5%, 6%, 7%, 8%, 9%, 10%, 11%, 12%, 13%, 14%, or 15%, or any value therebetween. In some embodiments, the water-soluble polymer is present in the aqueous phase in amount of about 3% to about 12%, or about 5% to about 10% by weight of the dry weight of the oil phase.

In some embodiments, the aqueous phase further comprises a water-soluble low molecular weight chain extender or crosslinker. The inclusion of the water-soluble low molecular weight chain extender or crosslinker may increase the degree of crosslinking of the random polymerization product. Examples of a water-soluble low molecular weight chain extender or crosslinker include, but are not limited to, multifunctional amines such as ethylene diamine, diethylene triamine, and triethylene tetraamine.

In some embodiments, the aqueous phase further comprises a surfactant. In some embodiments, the surfactant is a non-ionic surfactant. In some embodiments, the non-ionic surfactant preferably has an average HLB (hydrophilic-lipophilic balance) value of about 12 to about 15. Non-ionic surfactants include, but are not limited to, TRITON™ X-114 ((1,1,3,3-tetramethylbutyl)phenyl-polyethylene glycol), SILWET™ L-7604 (siloxane polyalkyleneoxide copolymer), and a combination thereof.

Weight percentage of the surfactant in the aqueous phase is calculated by the amount present in the oil phase for interaction with or adsorption on the oil phase. The surfactant may be present in the aqueous phase in an amount of about 0.01% to about 2% by weight based on the dry weight of the oil phase. This includes about 0.05%, 0.075%, 0.1%, 0.25%, 0.5%, 0.75%, 1%, 1.25%, 1.5%, 1.75%, or 2%, or any value therebetween. In some embodiments, the surfactant is present in the aqueous phase in an amount of about 0.05% to about 2%, or about 0.1% to about 1% by weight based on the dry weight of the oil phase.

In some embodiments, the aqueous phase further comprises a defoamer or antifoamer. In some embodiments, the defoamer is FOAMSTAR® ST 2410 (star polymer-based defoamer).

It will be appreciated that the polymers described herein and the general method to prepare them offers a great deal of versatility to adjust and fine-tune physical and chemical properties and their antimicrobial properties for a wide range of different surfaces, substrates and applications. Examples of variables available for this fine-tuning include, but are not limited to, the structure and amount of the first quaternary ammonium salt, the polyol, the optional chain extender), the water-soluble polymer, the first multifunctional crosslinker (e.g., the first polyisocyanate), the optional second quaternary ammonium salt, the optional second multifunctional crosslinker, and the degree of cross-linking. It will also be appreciated that multifunctional crosslinker(s) other than polyisocyanates may be used such as, but not limited to, multifunctional epoxides, imines, carbodiimides and aldehydes.

In another aspect, provided herein is an antimicrobial coating, coating fluid, or spraying fluid comprising, consisting essentially of, or consisting of an antimicrobial composition described herein. In some embodiments, the coating fluid or spraying fluid is water soluble or water dispersible.

In another aspect, provided herein is a device, equipment, apparatus, or accessory comprising the antimicrobial coating, coating fluid, or spraying fluid described herein. Non-limiting examples of the device, equipment, apparatus, or accessory include a filter, an air purifier, mask, or other personal protection device (PPD), respirator, etc. Other non-limiting examples include a keyboard, a keypad, a stylus, a mouse, a remote controller, a touch screen, a phone, and a display or any device integrating any of the foregoing components.

In another aspect, provided herein is a personal care aid comprising the coating, coating fluid, or spraying fluid described herein. Non-limiting examples of a personal care aid include facial tissue, hand soap, and a cleansing pad.

### Methods of Use

In another aspect, provided herein is a method to sanitize a surface, the method comprising, consisting essentially of, or consisting of applying a composition disclosed herein to the surface.

In another aspect, provided herein is a method to reduce (e.g., minimize) antimicrobial growth on a surface, the method comprising, consisting essentially of, or consisting of applying a composition disclosed herein to the surface. In some embodiments, the method includes forming a coating solution containing a composition according to any of the embodiments set forth herein. The method further includes directing, via an applicator (e.g., a sprayer), the coating solution to a surface, and providing a coating on the surface through the application of the coating solution to the surface.

In another aspect, provided herein is a method to prevent antimicrobial growth on a surface, the method comprising, consisting essentially of, or consisting of applying a composition disclosed herein to the surface.

In some embodiments of the methods described above, the applying step comprises, consists essentially of, or consists of spraying or brushing the surface with the composition. In some embodiments of the methods described above, the applying step comprises, consists essentially of, or consists of dipping the surface into a coating solution containing a composition according to any of the embodiments set forth herein. In some embodiments of the methods described above, the applying step comprises, consists essentially of, or consists of applying the composition to the surface by an electrostatic process.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. Moreover, due to biological functional equivalency considerations, some changes can be made in protein structure without affecting the biological or chemical action in kind or amount. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The technology described herein is further illustrated by the following examples which in no way should be construed as being further limiting. Although methods and materials similar or equivalent to those described herein can be used in the practice or testing of this disclosure, suitable methods and materials are described below.

### EXAMPLES

The present technology now being generally described, it will be more readily understood by reference to the following examples. These are included merely for purposes of illustration of certain aspects and embodiments of the present technology and are not intended to limit the present technology.

### Example 1 Representative Example of the Present Technology

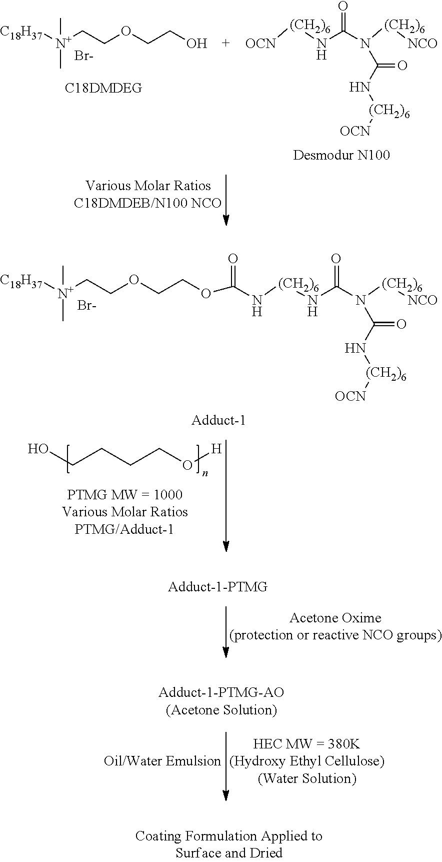

### A. Preparation of Adduct-1

5.0 g (10.7 mmol) of thoroughly dried C18DMDEG was added to a solution of 7.67 g (16.03 mmol, 48 mmol reactive NCO) of DESMODUR® N100 in 5 g dry toluene at 90° C. under nitrogen and allowed to react for 15 hours. A clear viscous liquid (Adduct-1) was obtained after the toluene was removed under reduced pressure.

### B. Preparation of Adduct-1-PTMG Pre-Polymer

0.54 g (0.54 mmol, 1.08 mmol OH) of polytetramethylene glycol (PTMG, MW=1000) was mixed with 1.83 g of the Adduct-1 (˜5.59 mmol NCO) and allowed to react for 2 hours at 80° C. under nitrogen and then allowed to cool to room temperature affording Adduct-1-PTMG pre-polymer.

### C. Preparation of Adduct-1-PTMG-AO

0.07 g (0.96 mmol) of dry acetone oxime (AO) in 0.46 g dry acetone were added into the Adduct-1-PTMG pre-polymer from Example 2. This was mixed thoroughly at room temperature by a vortex mixer for 30 min to assure that the mixture was completely homogeneous followed by gentle mixing for an additional 30 min until the oxime was completely reacted as evidenced by the decrease in the NCO peak monitored by FTIR spectroscopy to afford the Adduct-1-PTMG-AO product.

### D. Preparation of Aqueous Phase

3.48 g of hydroxyethyl cellulose (HEC, MW=380K, 3.52% aqueous solution,) was diluted with 0.63 g of water and the pH adjusted to 4.0 by 1N HCl.

### E. Preparation of Oil/Water Emulsion Coating Formulation and Surface Coating

The solution from Step C and the aqueous solution from Step D were thoroughly mixed together in a sonicator, and the resulting emulsion was immediately coated onto PET with a target dry thickness of approximately 25 μm. The coating was dried at room temperature for 10 min, heated to 60° C. for about 1-2 hours, and then additionally dried at room temperature overnight. It was found that this formulation afforded an emulsion “green time” (the time before the emulsion thickens too much to be coated) of approximately 15 minutes compared to a control (in which the oxime isocyanate protection step was eliminated) which had a green time of approximately 9 minutes.

### Example 2 Assessment of the Antiviral Activity of the Polymers and/or Coatings Thereof

The present study was conducted to assess the antiviral activity of the polymer coatings of the present technology. All samples and all accessories in the assessment were first disinfected by either high temperature autoclave treatment, alcohol cleaning or irradiation in a UV laminar flow chamber.

First, adenovirus (108 PFU/mL, plaque forming unit, MOl=100 multiplicity of infection) was diluted to 2×10⁷ PFU/ml in a phosphate buffer solution (PBS). Then, 0.1 mL of the diluted virus solution was deposited on the disinfected samples.

The antiviral activity was determined by two different methods: (i) the human cell (HuH7) method; and (ii) the quantitative reverse transcription polymerase chain reaction (RT-qPCR) method.

### (i) Human Cell (HuH7) Method

Huh7 is a type of human liver cell line that may be grown in the laboratory for research purposes. According to the web site huh7.com, it is “a well differentiated hepatocyte-derived carcinoma cell line, originally taken from a liver tumor in a 57-year-old Japanese male in 1982.”

For the assessment of antiviral activity, 0.1 mL of the virus (Adenovirus) in Dulbecco's Modified Eagle Medium (DMEM)+10% fetal bovine serum (FBS) medium was dropped onto the coating and also onto a control substrate and allowed to sit on the coating for 30 minutes. The virus/medium mixture was transferred to a Petri dish containing HuH7 cells (human liver cells) in the medium. The residual virus on the coating was rinsed twice with 0.1 mL of the medium and the liquid combined with the virus fluid in the Petri dish. The Petri dish was transferred to a CO₂ incubator and incubated at 37° C. with a relative humidity of about 95% and a CO₂ concentration of about 5% for 48 hours to amplify the signal.

Once the incubation was completed, visible light and fluorescence micrographs were taken of the virus/cell samples to determine the population of virus and the live/dead cells. For positive control, 0.1 mL of virus in the medium was transferred directly into the petri dish containing HuH7 cells in the medium.

### (ii) RT-qPCR Method

RT-qPCR is used in a variety of applications including pathogen detection, gene expression analysis, RNAi validation, microarray validation, genetic testing, and disease research.

### Sample Preparation

The medium (DMEM, high sucrose, pyruvate; ThermoFisher, Catalog number: 11995040) was removed from the refrigerator and conditioned in a water bath at 37° C. for 30 min.

Preparation of Virus Fluid: The typical virus count of the stock is 5 Lambda (5×10⁸) per tube. To the virus tube, 1 mL of DMEM medium was added and the tube was mixed homogeneously with a vortex mixer for 5-10 sec to make a virus fluid of 5×10⁸/mL concentration. The virus fluid was further diluted to 5×10⁷/mL with DMEM medium for the antivirus tests.

RT-qPCR Procedure for Coatings: The coated film was immersed in 99% alcohol for 1 sec. Any excess alcohol was removed from the surface. The film was then air-dried in a new petri dish for 15-20 min. Then 100 μL of the diluted virus fluid (5×10⁶/mL) was dropped onto the dried film. The petri dish was covered, and the virus allowed to contact the film for desired contact time period. In some of the experiments, the contact time was reduced to as short as 30 sec. The virus fluid from the film was transferred to an Eppendorf tube. The film was then rinsed twice with 50 μL of 1×PBD and the rinsing fluid was combined into the Eppendorf tube. The total test fluid volume was 200 μL and ready for the DNA extraction.

RT-qPCR Procedure for Aqueous Solutions: 100 μL of the test sample was added to 100 μL of the diluted virus fluid (5×10⁷/mL) in an Eppendorf tube and the mixture (5×10⁶ virus count) was shaken on a shaker for 30 min. DNA was extracted using the Novogene DNA kit following the specified extraction procedure.

RT-qPCR Tests: Each sample was tested in quadruplicates. The ingredients listed in Table 1 were mixed thoroughly in an Eppendorf tube.

TABLE 1
Formulation of the premix for q-RT-PCR Test

| Items | Volume (μL) |
|---|---|
| DI Water | 15.4 |
| Forward-primer | 2.2 |
| Reverse-primer | 2.2 |
| Master mix buffer | 22.0 |
| (Kapa BioSystems | |
| PCR reagent) | |
| Sample DNA | 4.4 (Added as the last ingredient) |
| TOTAL VOLUME | 46.2 μL |

### EGFP Primer Sequence:

| | | | | |
|---|---|---|---|---|
| Forward-primer | FLenti-GFP | 5′AACCACTACCTgAgCACCCA3′(20) SEQ ID NO: 1 | 2 | OPC |
| Reverse-primer | RLenti-GFP | 5′gTCCATgCCgAgAgTgATCC3′(20) SEQ ID NO: 2 | 2 | OPC |

Ten μL of the premix was added to each cavity of a test plate, with three samples taken for each coating and each sample was done in quadruplicate. Accordingly, a total of 12 tests were done for each coating.

The plate was centrifuged to assure all the premix fluid flowed to the bottom of the cavities. The plate was then inserted into an Applied Biosystems QuantStudio 3 (ThermoFisher) to determine the Cycle Threshold (CT) number for the calculation of the antiviral efficiency. The antiviral efficiency was calculated quantitatively from the CT number. TESTING

Qualitative Cell Viability Test for Coatings: The coating was placed in a petri dish and 100 μL of DMEM medium was dropped on the coating. The petri dish was then covered for 30 min. The medium on the film was then transferred to a cell plate containing 8×10⁴ cells in 500 μL of medium in each partition. The film was rinsed twice with 50 μL of DMEM medium and the rising fluid was combined with previous test fluid in the same location in the plate. A total of 200 μL of the test fluid was added to the 500 μL cell/medium. The cell plate was incubated at a 37° C./95% RH CO₂ incubator for 48-96 hours, after which the cell growth and morphology were observed under visible microscope. Dead cells floated or were suspended in the medium, while live cells remained fixed to the bottom of the plate. This test was for the assessment of the contact cytotoxicity of the polymer film. In cases where this test indicates some degree of cytotoxicity, the actual mechanism for the cell death is not given although cell death due to chemicals extracting from the coating are one possibility.

Qualitative Cell Viability Test for Polymer Solution or Dispersion: 100 μL of the polymer solution or dispersion and 100 μL of DMEM medium were added to an Eppendorf and mixed thoroughly with a shaker for 30 min. For polymer film, a fixed area of the film was cut and dispersed in the medium for the test. The test fluid was transferred to the cell plate and the cells were grown in a 37° C./95% RH CO₂ incubator for 48-96 hours. The cell growth and morphology were recorded under visible microscope.

Qualitative Antiviral Efficiency Test of Polymer film: 100 μL of the virus fluid (5×10⁷/mL) was dropped on the polymer film in a petri dish. The petri dish was covered for 30 min. The virus fluid was transferred to a cell plate containing 8×10⁴ cells in 500 μL of medium in each partition. The film was then rinsed twice with 50 μL of DMEM medium and the rising fluid was combined with previous test fluid in the same location in the plate. The total volume of the test fluid was 200 μL. The cell plate was then incubated at a 37° C./95% RH 002 incubator for 48-96 hours. Finally, the cell morphology and the fluorescence were recorded under UV microscope.

Qualitative Antiviral Efficiency Test of Polymer Solution or Dispersion: 100 μL of the virus fluid (5×10⁷/mL) and 100 μL of the polymer solution or dispersion were added to an Eppendorf and shaken thoroughly with a shaker for 30 min. The test mixture was added in a cell plate containing 8×10⁴ cells in 500 μL of medium in each partition. The cell plate was then incubated at a 37° C./95% RH 002 incubator for 48-96 hours. Finally, the cell morphology and the fluorescence were recorded under UV microscope.

### Experimental Results—Antiviral Activity and Toxicity

The coating from Example 1 was tested against a range of bacteria, viruses and fungi. Select data are shown in Tables 2 and 3 below.

TABLE 2

| | Antibacterial Efficiency | | | |
|---|---|---|---|---|
| | ISO 22196: 2011 | ASTM E2149 | | |
| Microbe | 24 h contact time | 24 h | 60 min | 30 min |
| Streptococcus pneumoniae ^{a, c} | >99.99% | | | |
| Streptococcus pyogenes ^{a, c} | >99.99% | | | |
| Clostridium difficile ^{a, c} | 99.33% | 81.20% | 31.10% | 36.20% |
| Staphylococcus aureus ^{a, c} | >99.99% | | | |
| Burkholderia cepacia ^{a} | 84.38% | | | |
| Salmonella enterica sbsp. Enterica ^{a, c} | >99.99% | | | |
| Staphylococcus aureus (GMRSA) ^{a, c} | >99.99% | >99.9% | >99.9% | >99.9% |
| Escherichia coli ^{b} | >99.99% | | | |
| Pseudomonas aeruginosa ^{b, c} | >99.99% | | | |
| Klebsiella pneumoniae ^{b} | >99.99% | | | |
| Acinetobacter baumannii ^{b, c} | >99.99% | | | |
| Aspergillus brasiliensis ^{d} | 96.92% | | | |
| Candida albicans ^{d} | >99.99% | | | |

^{a} Gram(+);
^{b} Gram(−);
^{c} drug resistant;
^{d} fungus

TABLE 3

| | Antiviral Efficiency | | |
|---|---|---|---|
| | ISO 21702: 2019 | | |
| | 24 h | 10 min | 1 min |
| | contact | contact | contact |
| Virus | time | time | time |
| Influenza A virus H3N2 | 99.13% | 52.14% | 4.50% |
| Influenza A virus H1N1 | 99.67% | 75.45% | 16.82% |
| Feline calicivirus F-9 | 98.80% | 36.90% | 6.67% |
| Human coronavirus 229E | >99.86% | 86.82% | 22.37% |

In contrast to coatings of the present technology, the quaternary PEI polymers shown below did not form colorless, transparent, durable water and alcohol resistant coatings and were only moderately antivirally active. The two latex quaternary polymers shown below exhibited antiviral activity but were toxic to HuH7 cells.

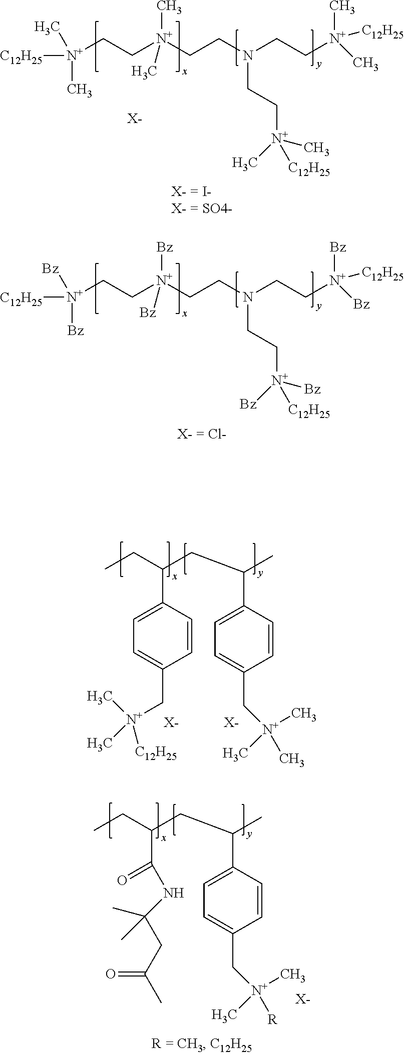

Mundex-W and Mundex-L-K (from Munditech, Germany) are two “self-disinfecting polymer emulsions” for treating surfaces. Both were found to be very weakly antiviral against adenovirus. Not unexpectedly, the water-based Mundex-W did not give a durable water or alcohol resistant surface coating. The solvent-based Mundex-L-K did give a more hydrophobic coating but its water or alcohol resistance was only marginal. Moreover, both of them were found toxic to HuH7 cells.

The LIVINGUARD® face mask includes an antiviral component. This mask exhibited only a marginal antiviral efficiency of ˜44% after one minute contact time and ˜72% after 20 minutes contact time. These efficiencies were significantly reduced after the mask was pre-conditioned at 40° C. 85% RH for 96 hours.

In conclusion, the antimicrobial polymers of the present technology produce surface coatings that displayed the following properties: (i) highly antimicrobial activity against viruses, bacteria, and fungus; (ii) fast acting; (iii) long lasting; (iv) non-toxic and nonallergenic; (v) no materials leaching out of the coating; (vi) colorless and transparent as a surface coating; (vii) easy application to a wide range of surfaces and materials; (viii) durable surface coating resistant to water and common solvents; and (ix) easy and cost effective to produce. Accordingly, these antimicrobial polymers represent an improved class of antimicrobial polymers.

### REFERENCES

¹ Ellingson, K. D., et al. (2020). “Urban Hospital Study—Antimicrobial Surface Coating.” Clinical Infectious Diseases, 71(8): 1807-1813.
² Jarach, N., et al., (2020). “Polymers in the Medical Antiviral Front-Line”. Polymers, 12(8): 1727.
³ THE MERCK MANUAL OF DIAGNOSIS AND THERAPY, (2011). 19^{th} Edition, published by Merck Sharp & Dohme Corp., (ISBN 978-0-911910-19-3).
⁴ THE ENCYCLOPEDIA OF MOLECULAR CELL BIOLOGY AND MOLECULAR MEDICINE, Robert S. Porter et al. (eds.), published by Blackwell Science Ltd., 1999-2012 (ISBN 9783527600908).
⁵ MOLECULAR BIOLOGY AND BIOTECHNOLOGY: A COMPREHENSIVE DESK REFERENCE, (1995). Robert A. Meyers (ed.), published by VCH Publishers, Inc. (ISBN 1-56081-569-8).
⁶ IMMUNOLOGY, (2006). Werner Luttmann, published by Elsevier.
⁷ JANEWAY'S IMMUNOBIOLOGY, (2014). Kenneth Murphy, Allan Mowat, Casey Weaver (eds.), Taylor & Francis Limited, (ISBN 0815345305, 9780815345305).
⁸ LEWIN'S GENES XI, (2014). published by Jones & Bartlett Publishers (ISBN-1449659055).
⁹ Michael Richard Green and Joseph Sambrook, (2012). MOLECULAR CLONING: A LABORATORY MANUAL, 4th ed., Cold Spring Harbor Laboratory Press, Cold Spring Harbor, N.Y., USA (ISBN 1936113414).
¹⁰ Davis et al., (2012). BASIC METHODS IN MOLECULAR BIOLOGY, Elsevier Science Publishing, Inc., New York, USA (ISBN 044460149X).
¹¹ LABORATORY METHODS IN ENZYMOLOGY: DNA, (2013). Jon Lorsch (ed.) Elsevier (ISBN 0124199542).
¹² CURRENT PROTOCOLS IN MOLECULAR BIOLOGY (CPMB), (2014). Frederick M. Ausubel (ed.), John Wiley and Sons (ISBN 047150338X, 9780471503385).
¹³ CURRENT PROTOCOLS IN PROTEIN SCIENCE (CPPS), (2005). John E. Coligan (ed.), John Wiley and Sons, Inc.
¹⁴ CURRENT PROTOCOLS IN IMMUNOLOGY (CPI) (2003). Coligan, J. E., et al., (eds.) John Wiley and Sons, Inc. (ISBN 0471142735, 9780471142737).
¹⁵ Ikonen, N., et al., (2018). “Deposition of respiratory virus pathogens on frequently touched surfaces at airports.” BMC Infectious Diseases, 18(437): 1-8.
¹⁶ Géczi, Z., et al., (2018). “Antimicrobial Silver-Polyethyleneimine Polylactic Acid Polymer Composite Film for Coating Methacrylate-Based Denture Surfaces.” J. of Nanomaterials, 2018(6): 1-9.
¹⁷ Park, D., et al., (2006). “One-Step, Painting-Like Coating Procedures To Make Surfaces Highly and Permanently Bactericidal.” Biotechnology Prog. 22(2): 584-589.
¹⁸ Xue, Y. and Xiao, H. (2015). “Antibacterial/Antiviral Property and Mechanism of Dual-Functional Quaternized Pyridinium-Type Copolymer.” Polymers, 7(11): 2290-2303.
¹⁹ U.S. Pat. No. 5,783,502, “Virus Inactivating Coatings.” (Issued Jul. 21, 1998).
²⁰ Nurdin, N., et al., (1993). “Biocidal Polymers Active By Contact. II. Biological Evaluation of Polyurethane Coatings with Pendent Quaternary Ammonium Salts.” J. of Applied Polymer Science, 50: 663-670.
²¹ Chung, S., et al., (2016). “Antimicrobial Nanostructural Polyurethane Scaffolds.” Ch. 17 in ADVANCES IN POLYURETHANE BIOMATERIALS, Cooper S. L. and Guan, J. (eds.), Elsevier Ltd.
²² Park, D., et al., (2013). “Antiviral and Antibacterial Polyurethanes of Various Modalities.” Appl. Biochem. Biotechnol., 169: 1134-1146.
²³ Gao, B., et al., (2007). “Studies on the Preparation and Antibacterial Properties of Quaternized Polyethyleneimine.” J. Biomaterials Science, Polymer Edition, 18(5): 531-544.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicant(s) and does not constitute any admission as to the correctness of the dates or contents of these documents.

The foregoing written specification is considered to be sufficient to enable one skilled in the art to practice the present aspects and embodiments. The present aspects and embodiments are not to be limited in scope by examples provided, since the examples are intended as a single illustration of one aspect and other functionally equivalent embodiments are within the scope of the disclosure. Various modifications in addition to those shown and described herein will become apparent to those skilled in the art from the foregoing description and fall within the scope of the appended claims. The advantages and objects described herein are not necessarily encompassed by each embodiment. Those skilled in the art will recognize, or be able to ascertain using no more than routine experimentation, many equivalents to the specific embodiments described herein. Such equivalents are intended to be encompassed by the following claims.

1. An antimicrobial composition comprising an oil-in-water emulsion, the oil-in-water emulsion comprising:
(i) an oil phase comprising
a first adduct of a first multifunctional crosslinker and a first quaternary ammonium salt, wherein the first quaternary ammonium salt has a reactive linking group to react with the first multifunctional crosslinker;
a polyol; and
optionally a second multifunctional crosslinker; and
(ii) an aqueous phase comprising a water-soluble polymer.

2. The antimicrobial composition of claim 1, wherein the water-soluble polymer is crosslinked with one or both of the first adduct and the second multifunctional crosslinker.

3. The antimicrobial composition of claim 1, wherein the first quaternary ammonium salt has a chemical structure of 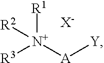
wherein
R¹ is selected from a group consisting of —(C₈-C₃₀ alkyl), —(C₈-C₃₀ heteroalkyl), —(C₈-C₃₀ heteroalkyl)-(C₆-C₁₀ aryl), —(C₆-C₁₀ aryl), —(C₆-C₁₀ aryl)-(C₈-C₃₀ alkyl), —(C₆-C₁₀ aryl)-(C₈-C₃₀ heteroalkyl), —(CR^{m}Rⁿ)ₓ₁₀—W¹⁰—(CR^{p}R^{q})_{y10}—H, and —(CR^{m}Rⁿ)ₓ₁₁—W¹¹—(CR^{p}R^{q})_{y11}H—; wherein —(C₈-C₃₀ heteroalkyl), —(C₈-C₃₀ heteroalkyl)-(C₆-C₁₀ aryl), and —(C₆-C₁₀ aryl)-(C₈-C₃₀ heteroalkyl) have 1 to 4 heteroatoms independently selected from O, S, and Si;
R² is selected from a group consisting of —(C₁-C₄ alkyl), —(C₁-C₄ heteroalkyl), —(C₁-C₄ heteroalkyl)-(C₆-C₁₀ aryl), —(C₆-C₁₀ aryl), —(C₆-C₁₀ aryl)-(C₁-C₄ alkyl), —(C₆-C₁₀ aryl)-(C₁-C₄ heteroalkyl), —(CR^{m}Rⁿ)ₓ₂₀—W²⁰—(CR^{p}R^{q})_{y20}—H, and —(CR^{m}Rⁿ)ₓ₂₁—W²¹—(CR^{p}R^{q})_{y21}—H; wherein —(C₁—C₄ heteroalkyl), —(C₁-C₄ heteroalkyl)-(C₆-C₁₀ aryl), and —(C₆-C₁₀ aryl)-(C₁-C₄ heteroalkyl) have 1 to 2 heteroatoms independently selected from O, S, and Si;
R³ is selected from a group consisting of —(C₁-C₃₀ alkyl), —(C₁-C₃₀ heteroalkyl), —(C₁-C₃₀ heteroalkyl)-(C₆-C₁₀ aryl), —(C₆-C₁₀ aryl), —(C₆-C₁₀ aryl)-(C₁-C₃₀ alkyl), —(C₆-C₁₀ aryl)-(C₁-C₃₀ heteroalkyl); —(CR^{m}Rⁿ)ₓ₃₀—W³⁰—(CR^{p}R^{q})_{y30}—H, and —(CR^{m}Rⁿ)ₓ₃₁—W³¹—(CR^{p}R^{q})_{y31}—H; wherein —(C₁-C₃₀ heteroalkyl), —(C₁-C₃₀ heteroalkyl)-(C₆-C₁₀ aryl), and —(C₆-C₁₀ aryl)-(C₁-C₃₀ heteroalkyl) have 1 to 4 heteroatoms independently selected from O, S, and Si;
A is a linking group selected from a group consisting of —(C₃-C₂₀ alkylene)-, —(C₃-C₂₀ heteroalkylene)-, —(C₆-C₁₀ arylene)-(C₃-C₂₀ alkylene)-, —(CR^{m}Rⁿ)ₓ₄₀—W⁴⁰—(CR^{p}R^{q})_{y40}—, and —(CR^{m}Rⁿ)ₓ₄₁—W⁴¹—(CR^{p}R^{q})_{y41}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m}, Rⁿ, R^{p}, and R^{q} is independently selected from H and C₁-C₄ alkyl;
W¹⁰, W²⁰, W³⁰, and W⁴⁰ are independently selected from —C(O)—; —C(O)O—; —OC(O)—; —C(O)NH—; and —NHC(O)—;
W¹¹, W²¹, W³¹, and W⁴¹ are independently selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x10 is an integer from 1 to 30 and y10 is an integer from 0 to 29, wherein 8≤(x10+y10)≤30;
x11 is an integer from 1 to 30 and y11 is an integer from 0 to 29, wherein 8≤(x11+y11)≤30;
x20 is an integer from 1 to 4 and y20 is an integer from 0 to 3, wherein x20+y20≤4;
x21 is an integer from 1 to 4 and y21 is an integer from 0 to 3, wherein x21+y21≤4;
x30 is an integer from 1 to 30 and y30 is an integer from 0 to 29, wherein x30+y30≤30;
x31 is an integer from 1 to 30 and y31 is an integer from 0 to 29, wherein x31+y31≤30;
x40 is an integer from 1 to 19 and y40 is an integer from 1 to 19, wherein 3≤(x40+y40)≤20;
x41 is an integer from 1 to 20, and y41 is an integer from 0 to 19, wherein 3≤(x41+y41)≤20;
Y is selected from a group consisting of —OH, —NHR⁴, —SH, —CO₂H, —C(O)NHR⁴, —C(S)NHR⁴, 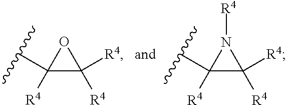
each R⁴ is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

4.-16. (canceled)

17. The antimicrobial composition of claim 1, wherein the first multifunctional crosslinker is a first polyisocyanate, and the second multifunctional crosslinker, when present, is a second polyisocyanate, and the first polyisocyanate and the second polyisocyanate are different or the same.

18.-20. (canceled)

21. The antimicrobial composition of claim 17, wherein each of the first and second polyisocyanates is prepared from a diisocyanate independently selected from a group consisting of hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

22.-24. (canceled)

25. The antimicrobial composition of claim 17, wherein reactive isocyanate functionality on the first adduct is protected with a blocking agent.

26. The antimicrobial composition of claim 25, wherein the blocking agent is selected from a group consisting of oximes, phenols, malonates, alcohols, lactams, dicarbonyl compounds, hydroxamates, bisulfite addition compounds, hydroxylamines, esters of p-hydroxybenzoic acid and salicylic acid.

27.-30. (canceled)

31. The antimicrobial composition of claim 1, wherein the oil phase further comprises an organic solvent or diluent.

32.-35. (canceled)

36. The antimicrobial composition of claim 1, wherein the polyol is selected from a group consisting of polyether polyols, polyester polyols, polyacrylic polyols, polymethacrylic polyols, polycaprolactone polyols, polybutadiene polyols, poly(acrylonitrile-co-butadiene) polyols, polysiloxane polyols, a copolymer of any two or more thereof, and a combination of any two or more thereof.

37.-42. (canceled)

43. The antimicrobial composition of claim 1, wherein the water-soluble polymer is selected from a group consisting of hydroxyethyl cellulose (HEC), hydroxypropyl cellulose, polyvinyl alcohol, poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyacrylamide, polyethylene imine, a copolymer of two or more thereof, a copolymer of one or more thereof with polyvinylpyrrolidone poly(glycidyl acrylate) or with poly(glycidyl methacrylate), and a combination or blend of two or more thereof.

44.-56. (canceled)

57. The antimicrobial composition of claim 1, wherein a random polymer or an interpenetrating polymer network is produced from random polymerization/crosslinking of the first adduct, the polyol, the water-soluble polymer, and, when present, the second multifunctional crosslinker.

58. The antimicrobial composition of claim 1, wherein the oil phase further comprises a second adduct of (a) the first multifunctional crosslinker or a third multifunctional crosslinker, and (b) a second quaternary ammonium salt 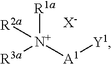
wherein
R^{1a}, R^{2a}, and R^{3a} are each independently methyl or ethyl;
A¹ is a linking group selected from a group consisting of —(C₃-C₂₀ alkylene)-, —(C₃-C₂₀ heteroalkylene)-, —(C₆-C₁₀ arylene)-(C₃-C₂ alkylene)-, —(CR^{m1}Rⁿ¹)ₓ₄₂—W⁴²—(CR^{p1}R^{q1})_{y42}—, and —(CR^{m1}Rⁿ¹)ₓ₄₃—W⁴³—(CR^{p1}R^{q1})_{y43}—, wherein —(C₃-C₂₀ heteroalkylene)- has 1 to 4 heteroatoms independently selected from O, S, and Si; and —(C₃-C₂₀ alkylene)- and —(C₃-C₂₀ heteroalkylene)- are optionally substituted with 1 to 6 substituents independently selected from —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl);
each R^{m1}, Rⁿ¹, R^{p1}, and R^{q1} is independently selected from H and C₁-C₄ alkyl;
W⁴² is selected from —C(O)—; —C(O)O—; —OC(O)—; —C(O)NH—; and —NHC(O)—;
W⁴³ is selected from 5- to 6-membered cycloalkyl, C₆-C₁₀ aryl, 5- to 6-membered heterocycloalkyl, and 5- to 6-membered heteroaryl, wherein the heterocycloalkyl contains 1-2 ring heteroatoms selected from O, N, S, and Si; and the heteroaryl contains 1-3 ring heteroatoms selected from O, N, S, and Si;
x42 is an integer from 1 to 19 and y42 is an integer from 1 to 19, wherein 3≤(x42+y42)≤20;
x43 is an integer from 1 to 20, and y43 is an integer from 0 to 19, wherein 3≤(x43+y43)≤20;
Y¹ is selected from a group consisting of —OH, —NHR^{4a}, —SH, —CO₂H, —C(O)NHR^{4a}, —C(S)NHR^{4a}, 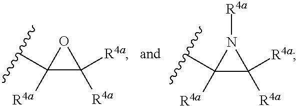
each R^{4a} is independently selected from a group consisting of H, —(C₆-C₁₀ aryl)-(C₁-C₃ alkyl), —(C₆-C₁₀ aryl)-(C₁-C₃ heteroalkyl), —(C₁-C₃ alkyl)-(C₆-C₁₀ aryl), —(C₁-C₃ heteroalkyl)-(C₆-C₁₀ aryl), and —(C₆-C₁₀ aryl), wherein —(C₆-C₁₀ aryl)-(C₁-C₃ heteroalkyl) and —(C₁-C₃ heteroalkyl)-(C₆-C₁₀ aryl) have 1 to 4 heteroatoms independently selected from O, S, and Si; and
X⁻ is independently acetate, halide, sulfate, sulfonate, phosphate, phosphonate, carbonate, silicate, hexafluorophosphate, hexafluoroantimonate, borate, or an organo-substituted derivative of any of the foregoing.

59.-70. (canceled)

71. The antimicrobial composition of claim 58, wherein a random polymer or an interpenetrating polymer network is produced from random polymerization/crosslinking of the first adduct, the second adduct, the polyol, the water-soluble polymer, and, when present, the second multifunctional crosslinker.

72. The antimicrobial composition of claim 1, wherein the oil phase further comprises a chain extender selected from a group consisting of HO—(CₙH₂ₙ)—OH and HO—(CₙH₂ₙ₋₂)—OH, or a combination thereof, wherein n is an integral between 2 and 8.

73.-76. (canceled)

77. A polymer or interpenetrating polymer network comprising a random polymerization/crosslinking product of reagents comprising (i) a first adduct of a first multifunctional crosslinker and a first quaternary ammonium salt; (ii) a polyol; (iii) a water-soluble polymer; and (iv) optionally a second multifunctional crosslinker; wherein the water-soluble polymer comprises hydroxyethyl cellulose, hydroxypropyl cellulose, methylcellulose, hydrophobically modified cellulose, polyvinyl alcohol poly(hydroxyethyl methacrylate-co-alkyl methacrylate), poly(hydroxyethyl methacrylate-co-alkyl acrylate), poly(hydroxyethyl acrylate-co-alkyl methacrylate), poly(hydroxyethyl acrylate-co-alkyl acrylate), polyethylene imine, polyacrylamide, or a combination or blend of two or more thereof, or a copolymer of two or more thereof, or a copolymer of one or more thereof with polyvinylpyrrolidone, poly(glycidyl acrylate) or with poly(glycidyl methacrylate).

78.-116. (canceled)

117. A composition comprising the polymer or interpenetrating polymer network of claim 77.

118. An antimicrobial coating, coating fluid, or spraying fluid comprising the composition of claim 1.

119. A device, equipment, apparatus, accessory, or personal care aid comprising the coating, the coating fluid or the spraying fluid of claim 118.

120.-124. (canceled)

125. A method to sanitize a surface, to reduce antimicrobial growth on a surface, or to prevent antimicrobial growth on a surface, the method comprising applying the composition of claim 1.

126.-129. (canceled)

130. A polymer or interpenetrating polymer network prepared by:
(a) reacting a first multifunctional crosslinker with a first quaternary ammonium salt to form a first adduct;
(b) optionally reacting the first multifunctional crosslinker or a third multifunctional crosslinker with a second quaternary ammonium salt to form a second adduct;
(c) combining the first adduct and, when present, the second adduct, with a polyol and optionally a second multifunctional crosslinker to form an oil phase;
(d) dissolving a water-soluble polymer in water to form an aqueous phase;
(e) combining the oil phase and the aqueous phase to form an oil-in-water emulsion; and
(f) applying the emulsion onto a surface and allowing the emulsion to dry and cure on the surface to form the polymer or interpenetrating polymer network on the surface.

131.-140. (canceled)
